(19) United States
(12) Patent Application Publication
(10) Pub. No.: US 2005/0027656 A1
(43) Pub. Date: Feb. 3, 2005

(54) A SYSTEM AND METHOD FOR MONITORING FACILITY DATA

(75) Inventors: Peter Arthur Tobler, Rogers, AR (US); David Michael Lech SR., Springdale, AR (US); Kevin Leonard Whitfield, Bentonville, AR (US); Aaron Earl Axxe, Rogers, AR (US); Jeffrey Keene Mullins, Fayetteville, AR (US); Michael James Craddock, Bella Vista, AR (US); William Wesley Griffith III, Springdale, AR (US); David Wesley Whisel, Springdale, AR (US); Scott Douglas Stillwell, Alma, AR (US); Harry W. Mock, Fayetteville, AR (US); Johnathan Dale Parker, Springdale, AR (US); Stacy W. Jaycox, Springdale, AR (US); Joel Garringer, Tulsa, OK (US); John Roach, Siloam Springs, AR (US); Charles V. Lepard, Roseville, MI (US)

Correspondence Address: BLACKWELL SANDERS PEPER MARTIN LLP, 720 OLIVE STREET, SUITE 2400, ST. LOUIS, MO, 63101, US

(73) Assignee: TYSON FOODS, INC., Springdale, AR (US)

(21) Appl. No.: 10/708,146

(22) Filed: Feb. 11, 2004

Related U.S. Application Data
(60) Provisional application No. 60/446,493, filed on Feb. 11, 2003.

(51) Int. Cl. H04K 1/00

(52) U.S. Cl. 705/53

(57) ABSTRACT

A system and method for monitoring facility data is disclosed. This includes at least one processor capable of receiving inputted data and generating alerts or alarms when scheduled activity does not occur, monitoring whether devices used in the facility are calibrated, determining what corrective actions are appropriate if defects occur, provide control over who and how users edit data, provide a pre-shipment review of products leaving a facility, determining disposition of at least one product, developing root causes for defects and scheduling tasks. There is an ability for a wide variety of individuals having access to exactly the same program with material added or blocked-out in terms of zones and data monitoring can be defined in terms of department, lines and processes with complete flexibility in configuration. There are both data collectors and data verifiers with the establishment of schedules and alarms tailored to each role.

### CROSS REFERENCE TO RELATED APPLICATIONS

This patent application claims priority to U.S. Provisional Patent Application Ser. No. 60/446,493 filed Feb. 11, 2003.

### BACKGROUND OF INVENTION

There is a significant amount of critical data that must be utilized and safely stored at a manufacturing or service facility, e.g., plant. This extends to data required by governmental regulation and data that verifies quality of the manufacturing or service operation. One illustrative, but nonlimiting, example of this type of data is that required by the United States Department of Agriculture, Food Safety and Inspection Service in the processing of meat. This type of regulatory data includes the Hazard Analysis Critical Control Points (HACCP) under 9 C.F.R. Section 304 et al. The implications of not being able to provide this data can be tremendous. Under the current system, paper copies must be kept in fireproof file cabinets. If this data is removed, there is the potential for the recall of all associated products since the safety of these products cannot be substantiated. This can run into the millions of dollars for the mere loss of paperwork. If there are any legal implications regarding the processing of products, the ability to prove that all products produced in a certain period of time fully comport with all quality criteria can be invaluable. This is especially true when the final product is a combination of steps with multiple entities contributing to the process. For one particular entity, being able to prove the quality of the process with recorded data, can provide a tremendous advantage in proving the lack of culpability in the production of a defective product and providing assurances to consumers regarding the quality of the products or services.

The present invention is directed to overcoming one or more of the problems set forth above.

### SUMMARY OF INVENTION

This invention relates to the monitoring of data utilized at a facility, and more particularly, to a system and method for monitoring of data for regulatory compliance and to optimize quality.

In one aspect of this invention, a system and method for monitoring facility data is disclosed. This system includes at least one processor capable of receiving inputted data and generating alerts or alarms when scheduled activity does not occur, monitoring whether devices used in the facility are calibrated, determining what corrective actions are appropriate if defects occur, provide control over who and how users can edit data, provides a pre-shipment review of products leaving a facility, determining disposition of at least one product, develops root causes for defects and the scheduling of tasks.

Another aspect of this invention includes the ability for a wide variety of individuals having access to exactly the same program with material added or blocked-out in terms of zones. This allows high-ranking officials of an organization and governmental inspectors to have access to the same program by specifically defining what can be viewed by that particular user.

Still aspect of this invention includes defining the facility in terms of department(s), line(s) and process(es) with complete flexibility in configuration.

Another aspect of this invention includes defining roles for both data collectors and data verifiers and establishing schedules and alarms tailored to each role.

Still another aspect of this invention includes monitoring a wide variety of quality information including statistical quality control parameters as well as governmental requirements such as that required by Hazard Analysis Critical Control Points (HACCP).

Yet, another aspect of this invention includes creating very flexible and logical categories that can be applied in virtually any environment including parts, fields, devices, unit of measurement, tests, models, manufacturers, assignable causes, remedial actions and workstations and associated types thereof.

Still another aspect of this invention includes creating a wide variety of reports to view facility data.

Another aspect of this invention includes scheduling a test, associating workstations, establishing control limits, verifying data, and placing a hold tag on data to prevent editing.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a schematic context diagram of the system and method for monitoring facility data;

FIG. 2 is an exemplary screen display of a login screen associated with the present invention;

FIG. 3 is an exemplary screen display of a password and pin number update screen associated with the present invention;

FIG. 4 is a flow chart of the data collection for a pocket processor that utilizes wireless communication associated with the present invention;

FIG. 5 is a flow chart of the data collection for a desktop processor or workstation associated with the present invention;

FIG. 6 is a flow chart of the data reporting for a desktop processor or workstation associated with the present invention;

FIG. 7 is a flow chart of the process to add users to the system associated with the present invention;

FIG. 8 is a flow chart of the process to create inspection points or data collection tests to the system associated with the present invention;

FIG. 9 is a flow chart of the process to create a schedule flow associated with the present invention;

FIG. 10 is a flow chart of the process to adding and updating part information associated with the present invention;

FIG. 11 is an exemplary screen display of facility, e.g., plant, location information associated with the present invention;

FIG. 12 is an exemplary screen display of user information associated with the present invention;

FIG. 13 is an exemplary screen display of departments, lines and processes associated with the present invention;

FIG. 14 is an exemplary screen display of part type information associated with the present invention;

FIG. 15 is an exemplary screen display for providing userid and pin information associated with the present invention to provide an electronic signature for adding new data to the system;

FIG. 16 is an exemplary screen display for providing userid and pin information associated with the present invention to provide an electronic signature along with a reason for updating existing data on the system;

FIG. 17 is an exemplary screen display of part information associated with the present invention;

FIG. 18 is an exemplary screen display of field group information associated with the present invention;

FIG. 19 is an exemplary screen display of field item information associated with the present invention;

FIG. 20 is an exemplary screen display of type of unit of measure information associated with the present invention;

FIG. 21 is an exemplary screen display of unit of measure information associated with the present invention;

FIG. 22 is an exemplary screen display of unit of type of testing information associated with the present invention;

FIG. 23 is an exemplary screen display of test information associated with the present invention;

FIG. 24 is an exemplary screen display of remedial action information associated with the present invention;

FIG. 25 is an exemplary screen display of assignable cause information associated with the present invention;

FIG. 26 is an exemplary screen display of measuring devices information associated with the present invention;

FIG. 27 is an exemplary screen display of a measuring device type information associated with the present invention;

FIG. 28 is an exemplary screen display of a measuring device manufacturer information associated with the present invention;

FIG. 29 is an exemplary screen display of a measuring device model information associated with the present invention;

FIG. 30 is an exemplary screen display of a device information associated with the present invention;

FIG. 31 is an exemplary screen display of a workstations information associated with the present invention;

FIG. 32 is an exemplary screen display of a workstation type information associated with the present invention;

FIG. 33 is an exemplary screen display of a workstation manufacturer information associated with the present invention;

FIG. 34 is an exemplary screen display of a workstation model information associated with the present invention;

FIG. 35 is an exemplary screen display of a workstation information associated with the present invention;

FIG. 36 is an exemplary screen display of a alarm rule information associated with the present invention;

FIG. 37 is an exemplary screen display of an alert and alarm report associated with the present invention;

FIG. 38 is an exemplary screen display of a calibration report associated with the present invention;

FIG. 39 is an exemplary screen display of a corrective action report associated with the present invention;

FIG. 40 is an exemplary screen display of a data edit report associated with the present invention;

FIG. 41 is an exemplary screen display of an interactive alert and alarm report associated with the present invention;

FIG. 42 is an exemplary screen display of a data verification report associated with the present invention;

FIG. 43 is an exemplary screen display of a hold tag report associated with the present invention;

FIG. 44 is an exemplary screen display of a pre shipment review report associated with the present invention;

FIG. 45 is an exemplary screen display of a query report and export function associated with the present invention;

FIG. 46 is an exemplary screen display of a reports log report associated with the present invention;

FIG. 47 is an exemplary screen display of a root cause report associated with the present invention;

FIG. 48 is an exemplary screen display of a workstation schedule report associated with the present invention; and

FIG. 49 is an exemplary screen display of specification limits information associated with the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as to obscure the present invention. For example, the invention is not limited to a particular type of software language or to particular conventions regarding software designations. A processor referred to in this Application can be a single processor or a whole series of processors. This also includes hand-held pocket personal computer and programmable logic controllers. The hand-held pocket personal computer communicates via radio frequency communication. The preferred method of communication for this invention is through a wide area network 12, e.g., Internet; however, there are numerous mechanisms for electronic communication that might suffice for this present invention. This invention described herein can be displayed on any type of electronic display such as a liquid crystal display, a cathode ray tube display and a plasma screen display. However, other types of electronic displays will suffice.

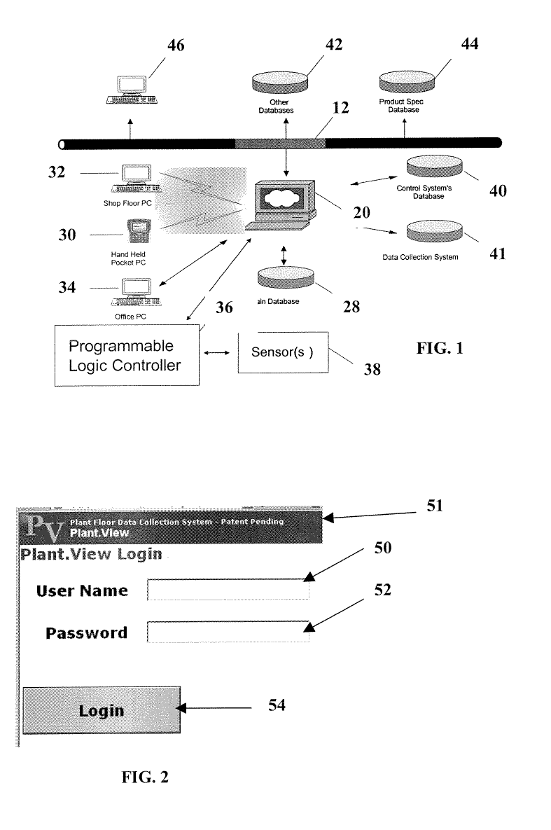

Referring now to the drawings, and initially to FIG. 1, where FIG. 1 is a contextual diagram of the system and method for monitoring facility data, which is generally indicated by numeral 10. There is a main server 20 that provides the facility data monitoring service associated with the present invention. Numerous types of servers can function as the main server 20.

The main server 20 interfaces with a main database 28. An illustrative, but nonlimiting, example of the type of information that can be placed on the main database is data involving a manufacturing process or service process. This can be inputted from a handheld pocket personal computer 30, a personal computer found on the shop or facility floor 32, a personal computer found in an office 34, and a programmable logic controller 36 that obtains data directly from at least one sensor 38. Preferably, but not necessarily, any one of these processors 30, 32, 34 and 36 may be connected to the main server 20 through wireless communication rather than a direct hardwired connection. There may be other databases 40 and 41 connected to the main server 20. There are numerous communication systems that may suffice such as local area networks, wireless communication, internet, and so forth with the preferred method of communication being a wide area network 12. This can connect to a product or service specification database 44 as well as a potential variety of other databases 42. These can connect to organization processors 46 for reviewing facility data and generating reports thereof.

The first step in the process is for a user to perform a log-in function that is generally indicated by numeral 51. This is accomplished by inputting a user name 50, a password 52 and then clicking on a “Login” graphical user input button 54, as shown in FIG. 2. Preferably, there will be security measures present such as displaying a security policy and an automatic logging-out feature if no action occurs within a predetermined time period, e.g., thirty (30) minutes.

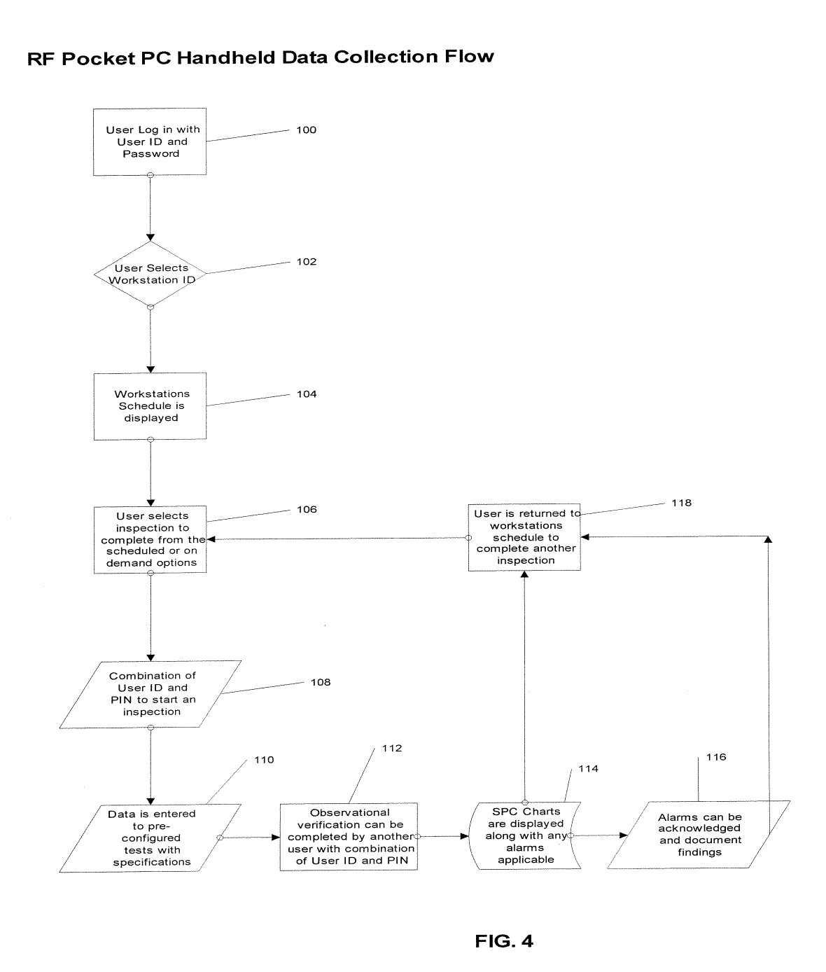

The software data monitoring algorithms will also be described herein. In the description of flowcharts, the functional explanation marked with numerals in angle brackets, <nnn>, will refer to the flowchart blocks bearing that number. In this case, the user “login” function is described by process steps <100>, <120>, <138>, <156>, <174>, <186> and <202>, for each of the process steps shown in FIGS. 4, 5, 6, 7, 8, 9 and 10, which will be described individually in greater detail below.

Referring now to FIG. 11, the first step is to identify a specific facility, e.g., plant, which is generally indicated by numeral 69. This can include entering a location name 70, a facility location code 72, a first identification number 74 (governmental/regulatory identification code), e.g., USDA plant number, a second identification number 76 (governmental/regulatory identification code), e.g., USDA establishment number, an address for a facility 78, a city for a facility 84, a state for a facility 82, a zip code for a facility 80, and a phone number for a facility 86. This information can be saved with a graphical user pushbutton interface that is indicated by numeral 88.

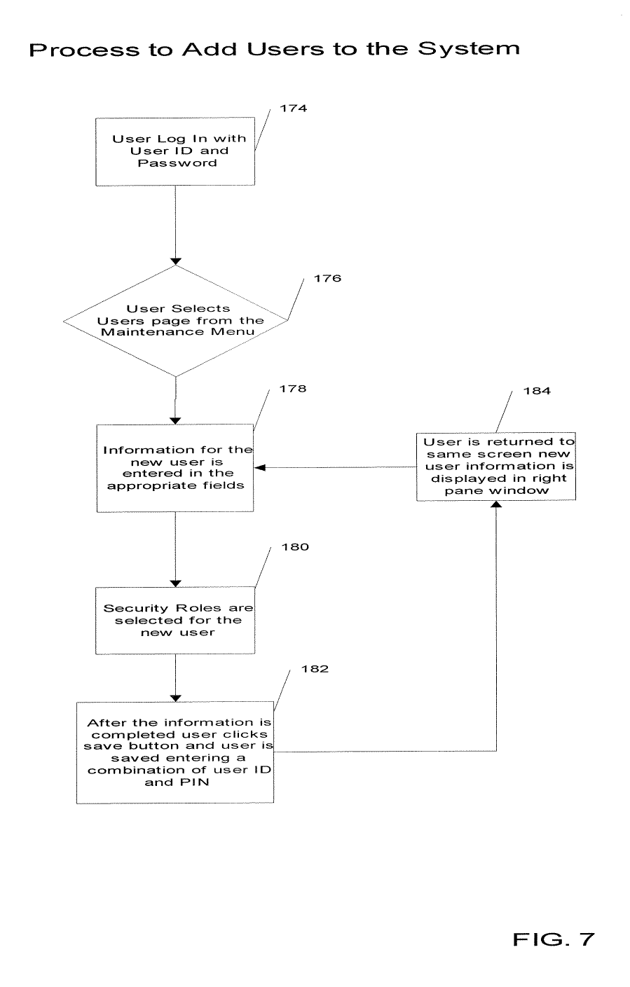

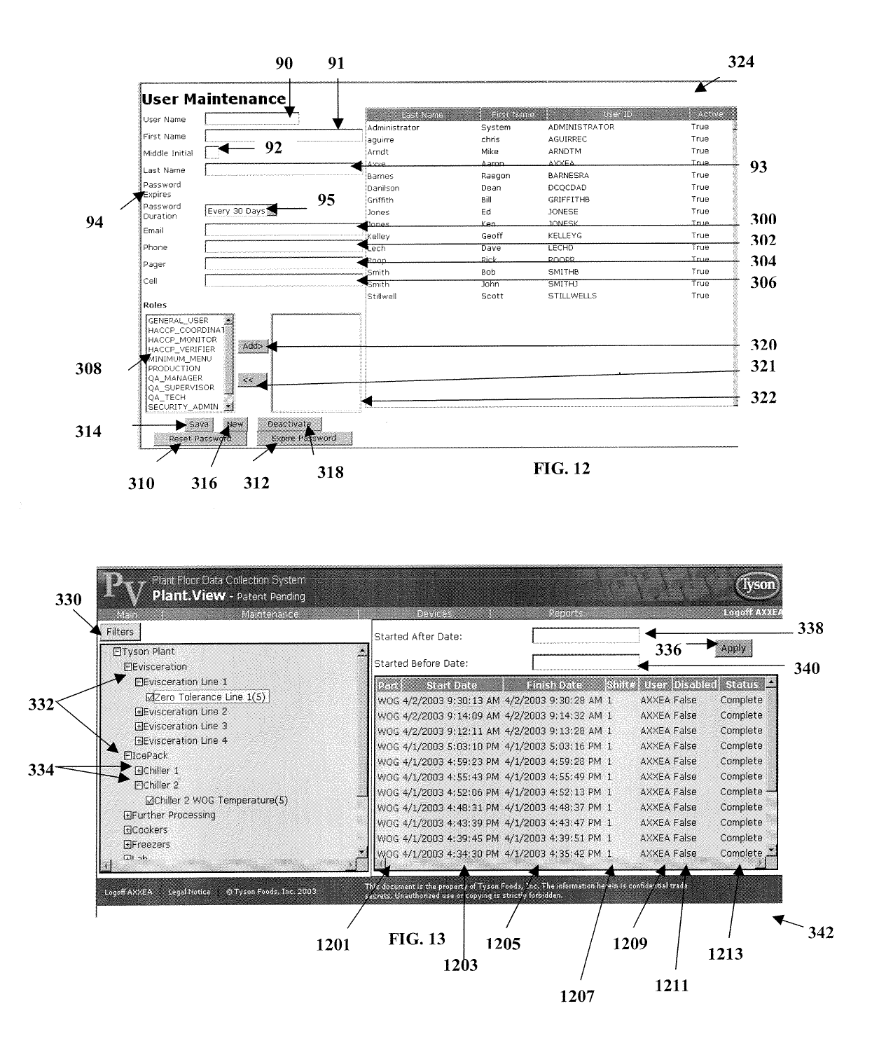

Referring now to FIGS. 7 and 12, the next step in the process is to add users to the system. The first step in this process is to perform the previously described “login” function <174>, and select a user maintenance graphical interface screen <176>, as shown in FIG. 7. The user maintenance graphical interface screen, as indicated by numeral 324, is then displayed, as shown in FIG. 12. The user selects potential users from screen 324 or inputs a user name, a first name, middle initial, and a last name of a potential new user in inputs 90, 91, 92 and 93, respectively.

The next step is to provide information for the new user in the appropriate fields <178>, as shown in FIG. 7. This includes utilizing a drop-down input to provide a duration period for a password 95, an e-mail address 300, a phone number 302, a pager number 304, and a cell phone number 306, as shown in FIG. 12. Also, there is a graphical user output display of the expiration date for the password 94.

The next step in the process is to select the security role for that specific user <180>, as shown in FIG. 7. The advantage to this program is that for each security user, different zone objects may appear. Therefore, the same program can be used for each type of user, with only different zones blocked out or visible. This is a unique advantage that allows the same graphical interface screens with the same program to be utilized for a wide variety of employees as well as governmental inspectors without requiring numerous software programs for each security role. Information is merely blocked-out from parties that are not authorized to view that certain information. A selection screen of available roles is indicated by numeral 308 as shown in FIG. 12. Security roles can be selected by graphical user interface button 320 to add that role to selection screen 322. Security roles for a particular individual can also be removed through graphical user interface button numeral 321.

After this information is entered, the user saves the information with the graphical user interface button indicated by numeral 314. This involves the entering of user identification and a personal identification number, which is indicated as process step <182> in FIG. 7. There is a graphical user interface button 316 for entering information for a new user, deactivating a user 318, resetting a password 310, and having a password expire 312.

When this information is saved in process step <182>, the user is returned via process step <184> to the same screen in process step <178>, however, that user's information is now available in screen 324, as shown in FIG. 12.

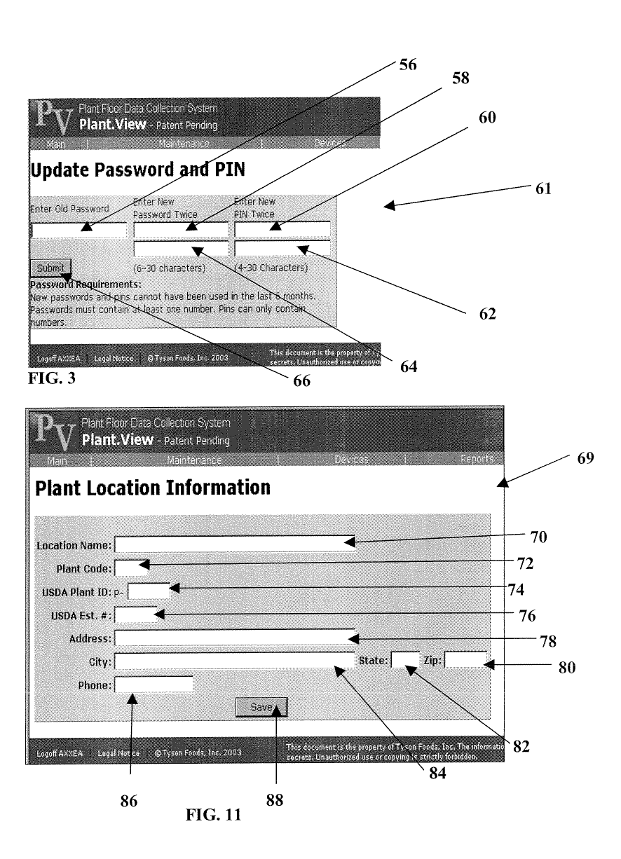

Data entry is performed by using a personal identification number or PIN number to provide an electronic signature. This is approved under 21 C.F.R. Section 11.3 as having the same legal force and effect as a handwritten signature or initials. There is a graphical user interface screen that is generally indicated by numeral 61, as shown in FIG. 3. The old password is first entered 56, which is followed by entering a new password in inputs 58 and 64. There is a new personal identification number or PIN number is also entered twice in inputs 60 and 62. There is a graphical user interface button 66 for inputting this information.

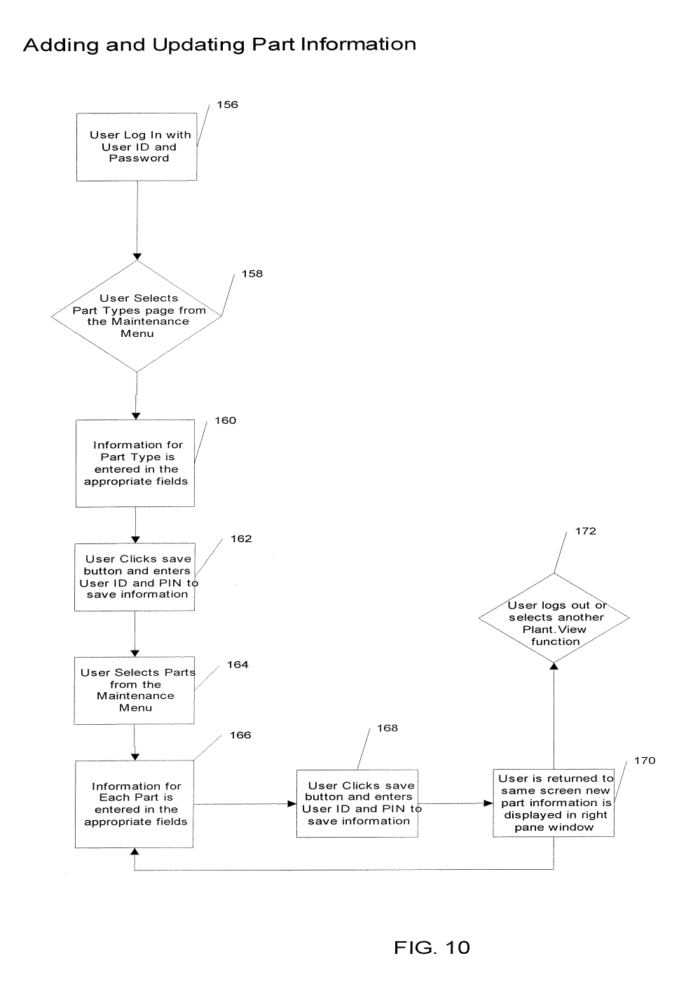

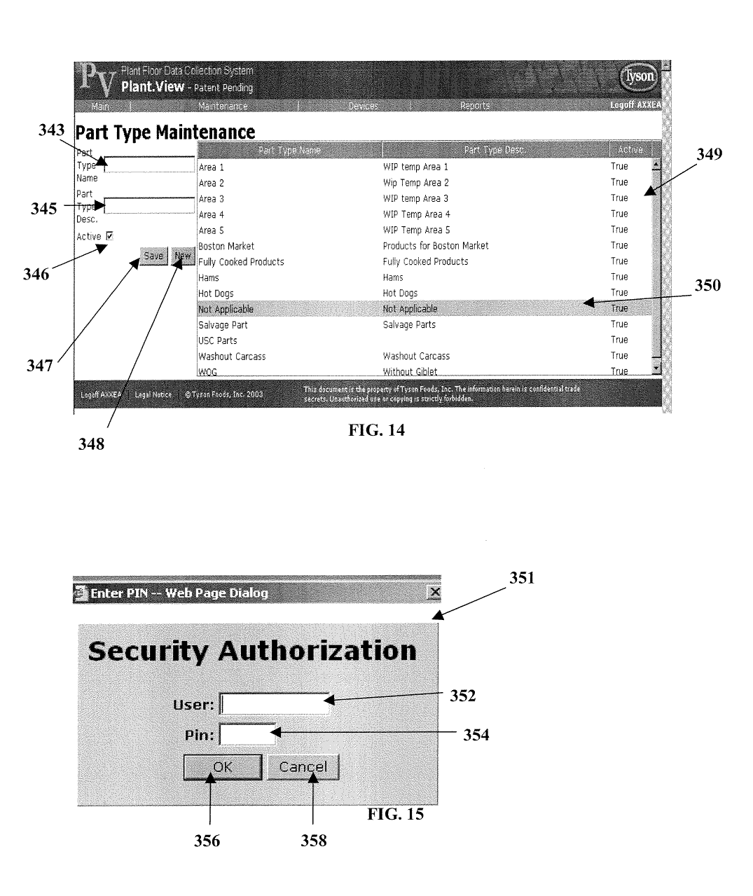

A major function of the present invention is to add and update parts. In this case, parts can include virtually anything. Examples include components, subassemblies, fully assembled products, machines used in manufacturing, and so forth. The first step in this process is to perform the previously described “login” function <156> and select a “part type” maintenance page screen from a graphical user interface screen <158>, as shown in FIG. 10. The “part type” page on the maintenance facility, e.g., plant, explorer graphical user interface screen is then displayed, as shown in FIG. 14, which is generally indicated by numeral 349.

The part type information can be provided in the appropriate fields <160>, as shown in FIG. 10. Illustrative examples of the “part type” information that can be inputted includes a part type name 343, a description of the part type 345 and a click-on input for whether a part type is active 346. The user then clicks on a “save” graphical user interface pushbutton 347 to save the information with the use of a userid and a personal identification number (PIN), as previously described <162>, as shown in FIG. 10. There is also a “new” graphical user interface pushbutton 348 to clear the part information so that new information can be inputted. The new part type, with description and indication as to whether it is active, then appears on an output screen as indicated by numeral 350.

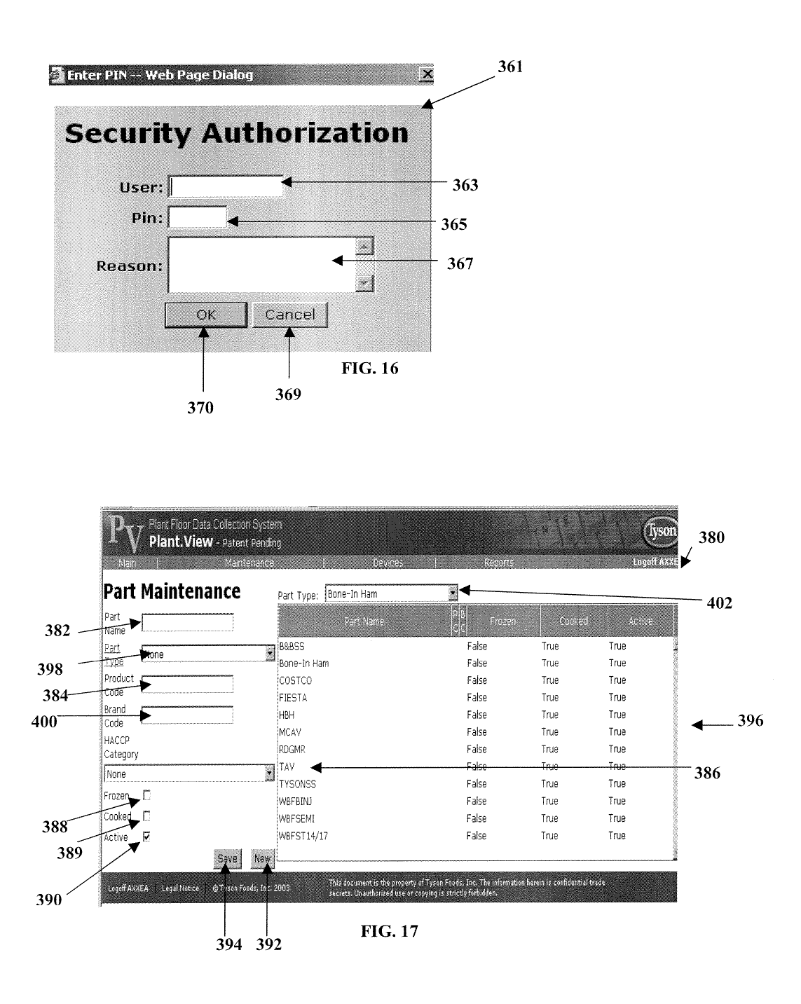

When a new part type is added, that is indicated by the graphical interface screen 351 shown on FIG. 15, which requires the correct security authorization with a user identification 352, personal identification number (PIN) 354, and a graphical user interface button to indicate input 356 or a graphical user interface button to cancel the addition of a part type 358. A part type can also be updated as indicated by the graphical interface screen 361 shown on FIG. 16, which requires the correct security authorization with a user identification name (userid) 363, personal identification number (PIN) 365, and a graphical user interface button to indicate input 370 or a graphical user interface button to cancel the update 369. There is an input screen 367 for providing typed verbiage that indicates the reason for the change 367 as an auditing and control type of feature.

The next step is to select a “part” page screen from a maintenance graphical user interface screen <164>, as shown in FIG. 10. The “part” page on the maintenance facility, e.g., plant, explorer graphical user interface screen 380 is then displayed, as shown in FIG. 17. The part information can be provided in the appropriate fields <166>, as shown in FIG. 10. Illustrative examples of the type of part information that can be inputted includes a part name 382, a drop-down input for a part type 398, a product code 384, a brand code 400, a drop-down input for a regulatory category, e.g., HACCP category, 386, and click-on inputs for product characteristics, e.g., frozen 388, cooked 389 and active 390. A previously inputted type of part can be provided through a drop-down input 402.

The user then clicks on a “save” graphical user interface pushbutton 394 to save the information with the use of a userid and a personal identification number (PIN), as previously described <168>, as shown in FIG. 10. There is also a “new” graphical user interface pushbutton 392 to clear the part information so that new information can be inputted. The new part, with description and indication as to whether it is active, then appears on an output screen as indicated by numeral 396, which is process step <170>, as shown in FIG. 10. At this point, the user can log out or select another function <172>.

Data can also be organized in field groups. Field groups are simply a way of organizing or relating items. An illustrative, but nonlimiting, example would include bone types, fecal contamination locations and sanitation standard operating procedures (“SSOP”) ratings for a food processing plant. SSOPs are written procedures detailing an organization's routine cleaning practices to promote a sanitary food production environment.

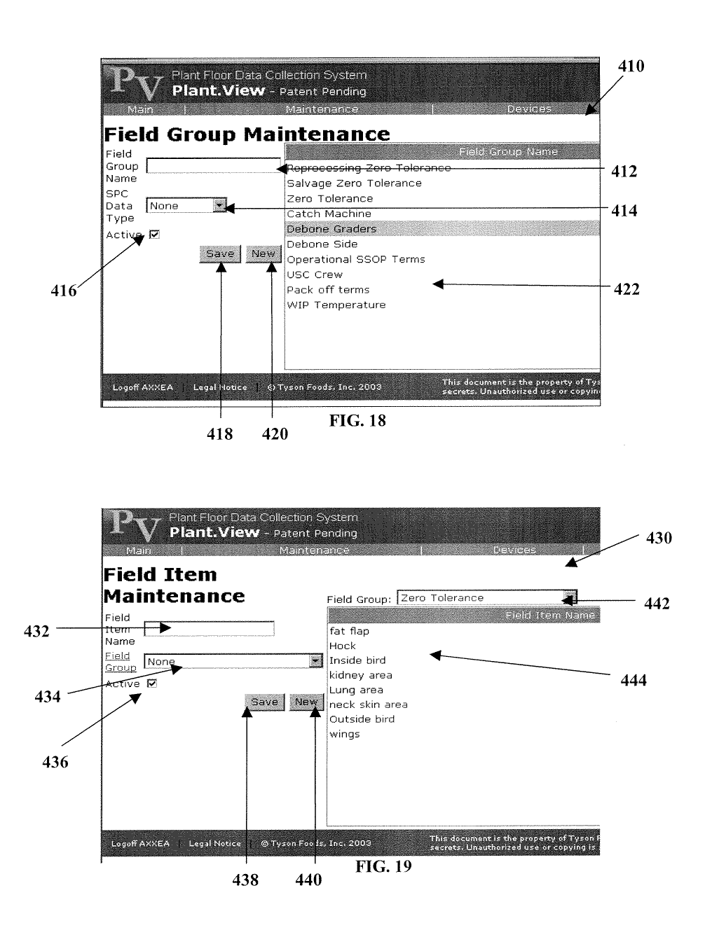

The process for adding and updating field groups is very similar to that for part types. The first step is to select a “field group” page screen on the maintenance facility, e.g., plant, explorer graphical user interface screen is then displayed, as shown in FIG. 18, which is generally indicated by numeral 410.

The field group information can be provided in the appropriate fields. Illustrative, but nonlimiting, examples of the “field group” information that can be inputted includes a field group name 412, a statistical process control (SPC) data type through a drop-down input 414, and a click-on input for whether a field group is active 416. The user then clicks on a “save” graphical user interface pushbutton 418 to save the information with the use of a userid and a personal identification number (PIN), as previously described. There is also a “new” graphical user interface pushbutton 420 to clear the field group information so that new information can be inputted. The new field group, with statistical process control data type and an indication as to whether it is active, then appears on an output screen as indicated by numeral 422. Field groups can be both added and updated in the same manner as a part type.

Each previously described field group includes a collection of at least one field item. The process for adding and updating field items is very similar to that for parts. The first step is to select a “field item” page screen on the maintenance facility, e.g., plant, explorer graphical user interface screen is then displayed, as shown in FIG. 19, which is generally indicated by numeral 430.

The field item information can be provided in the appropriate fields. Illustrative, but nonlimiting, examples of the “field item” information that can be inputted includes a field item name 432, a field group through a drop-down input 434 or 442, and a click-on input for whether a field item is active 436. The user then clicks on a “save” graphical user interface pushbutton 438 to save the information with the use of a userid and a personal identification number (PIN), as previously described. There is also a “new” graphical user interface pushbutton 440 to clear the field item information so that new information can be inputted. The new field item, with field item group and indication as to whether it is active, then appears on an output screen as indicated by numeral 444. Field items can be both added and updated in the same manner as a part type.

Data does include measurement data. The types of unit of measurement can be entered or updated. An illustrative, but nonlimiting, example of types of unit of measurement would include weight, count, temperature, percentage, string data and date.

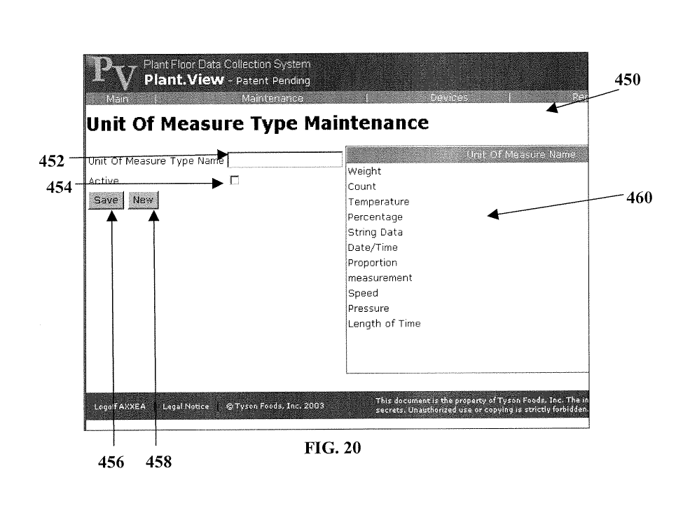

The process for adding and updating unit of measurement types is very similar to that for part types. The first step is to select a “unit of measurement type” maintenance page screen on the facility, e.g., plant, explorer graphical user interface screen is then displayed, as shown in FIG. 20, which is generally indicated by numeral 450. The type of unit of measurement information can be provided in a name field 452 and there is a click-on input for whether a unit of measurement is active 454. The user then clicks on a “save” graphical user interface pushbutton 456 to save the information with the use of a userid and a personal identification number (PIN), as previously described. There is also a “new” graphical user interface pushbutton 458 to clear the type of measurement unit information so that new information can be inputted. The new or updated type of unit of measurement field group and indication as to whether it is active then appears on an output screen as indicated by numeral 460. The types of unit of measurement can be both added and updated in the same manner as a part type.

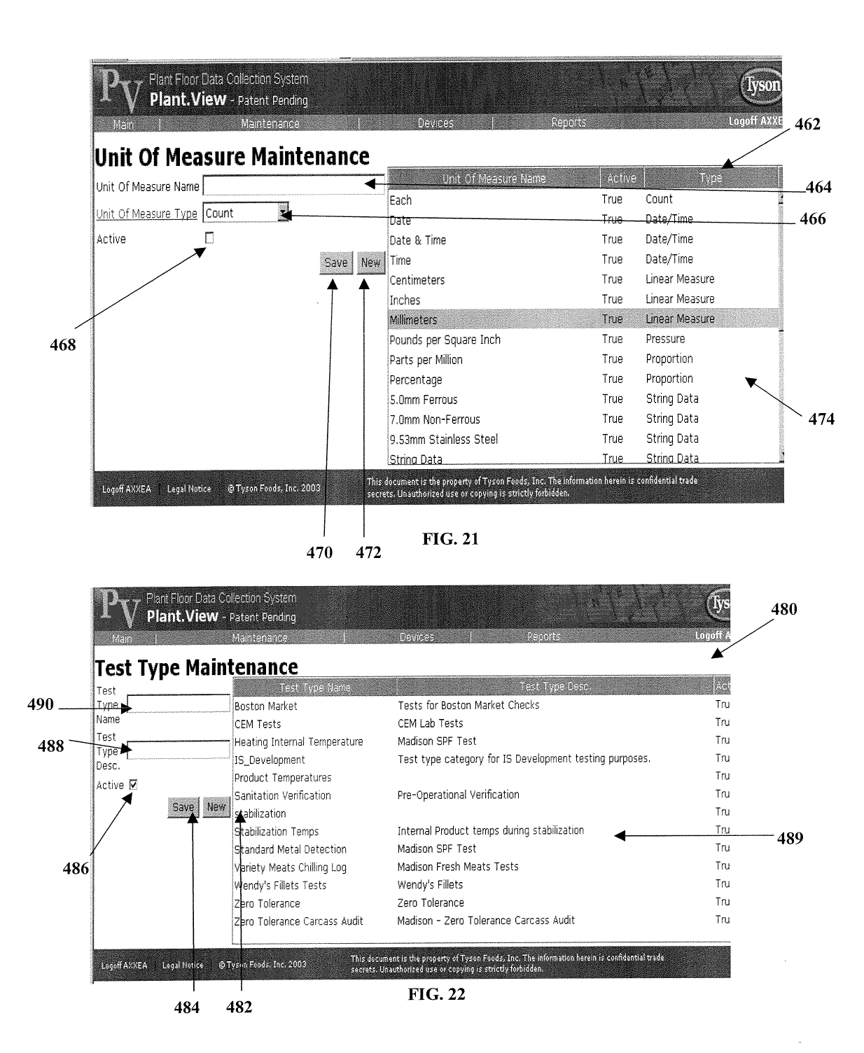

Each previously described type of unit of measurement includes at least one specific unit of measurement. The process for adding and updating specific units of measurement is very similar to the process for adding and updating parts. The first step is to select a “unit of measurement” maintenance page screen on the facility, e.g., plant, explorer graphical user interface screen is then displayed, as shown in FIG. 21, which is generally indicated by numeral 462. The specific unit of measurement can be provided in the appropriate fields. Illustrative, but nonlimiting, examples of the “unit of measurement” information that can be inputted includes a unit of measurement name 464, a type of unit of measurement through a drop-down input 466, and a click-on input for whether a unit of measurement is active 468. The user then clicks on a “save” graphical user interface pushbutton 470 to save the information with the use of a userid and a personal identification number (PIN), as previously described. There is also a “new” graphical user interface pushbutton 472 to clear the unit of measurement information so that new information can be inputted. The new or updated unit of measurement with the type of unit of measurement and indication as to whether or not it is active, then appears on an output screen as indicated by numeral 474. Unit of measurement items can be added or updated in the same manner as a part can be added or updated.

Data does include testing data. The types of tests can be entered or updated. An illustrative, but nonlimiting, example of types of tests would include temperature of a product at a particular point in the processing, inspection for fecal contamination, weight of the product, percentage of trisodium phosphate solution in processing cabinet, verification of critical limits, preshipment verification of product quality, thermometer calibration with comparison against NST certified standard weight, visual inspections regarding sanitation, and so forth, for a poultry processing plant.

The process for adding and updating types of tests is very similar to that for part types. The first step is to select a “test type” maintenance page screen on the facility, e.g., plant, explorer graphical user interface screen is then displayed, as shown in FIG. 22, which is generally indicated by numeral 480. The type of test information can be provided in a test type name field 490 and a description of the type of test can be provided in input 488. There is a click-on input for whether or not a type of test is active 486. The user then clicks on a “save” graphical user interface pushbutton 484 to save the information with the use of a userid and a personal identification number (PIN), as previously described. There is also a “new” graphical user interface pushbutton 482 to clear the type of test information so that new information can be inputted. The new or updated name for a type of test, a description of the type of test and an indication as to whether the type of test is active, then appears on an output screen as indicated by numeral 489. The types of tests can be both added and updated in the same manner as a part type, as described above.

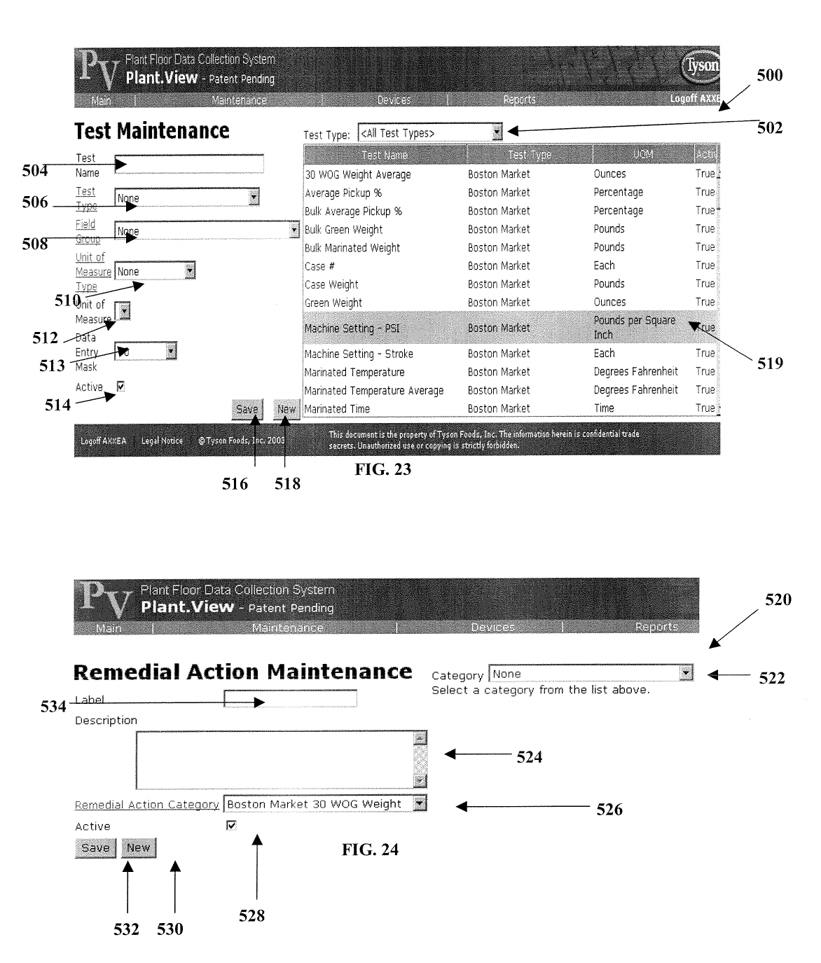

Each previously described type of test includes at least one specific test falling under that test type. The process for adding and updating a specific test is very similar to the process for adding and updating parts. The first step is to select a “test” page screen on the maintenance facility, e.g., plant, explorer graphical user interface screen is then displayed, as shown in FIG. 23, which is generally indicated by numeral 500. The specific test information can be provided in the appropriate fields. Illustrative, but nonlimiting, examples of test information that can be inputted includes a test name 504, a type of test through a drop-down input 506, a field group through a drop-down input 508, a type of unit of measure type through a drop-down input 510, a unit of measure through a drop-down input 512, a data entry mask through a drop-down input 513 and a click-on input for whether a test is active 514. The user then clicks on a “save” graphical user interface pushbutton 516 to save the test information with the use of a userid and a personal identification number (PIN), as previously described. There is also a “new” graphical user interface pushbutton 518 to clear the test information so that new test information can be inputted. The new or updated test, a type of test, a unit of measure and an indication as to whether or not it is active, then appears on an output screen as indicated by numeral 519. Test items can be added or updated in the same manner as a part can be added or updated.

Corrective or remedial action as well as causes of defects can be organized so that these items in the system can be readily retrieved. The first step in organizing types of remedial action is to select a “remedial action” page screen on the maintenance facility, e.g., plant, explorer graphical user interface screen is then displayed, as shown in FIG. 24, which is generally indicated by numeral 520. There is a drop-down input 522 to provide a category for a type of corrective action. The actual name of the corrective action can be labeled through input 534. The description of the corrective action can be typed-in through an input 524 that allows verbiage to be provided in sentence or paragraph format. There is another remedial action category indicated by numeral 526 and a click-on input 528 for indicating that it is an active remedial action. The user then clicks on a “save” graphical user interface pushbutton 532 to save the corrective action information with the use of a userid and a personal identification number (PIN), as previously described. There is also a “new” graphical user interface pushbutton 530 to clear the corrective action information so that new corrective action information can be inputted.

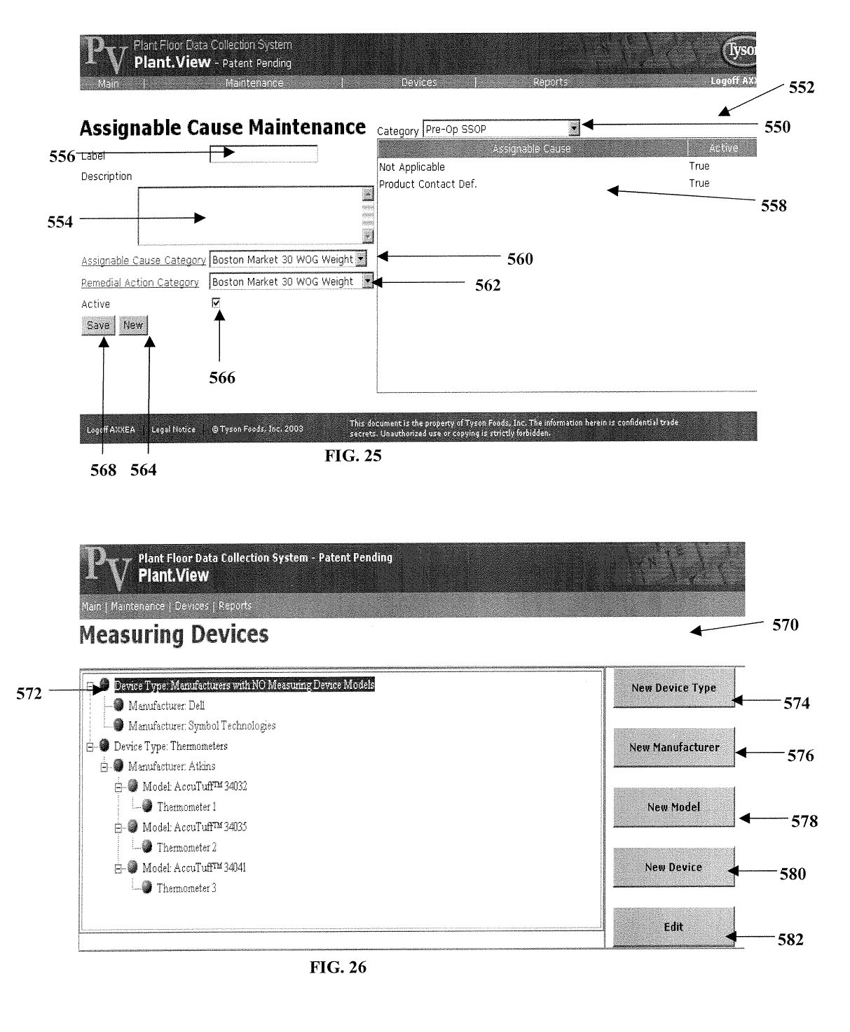

The first step in organizing causes to types of defects is to select an “assignable cause” maintenance page screen on the facility, e.g., plant, explorer graphical user interface screen is then displayed, as shown in FIG. 25, which is generally indicated by numeral 552. There is a drop-down input 550 to provide a category for a type of assignable cause for a defect. The actual name of the assignable cause for a defect can be labeled through input 556. The description of the assignable cause for a defect can be typed-in through an input 554 that allows verbiage to be provided in sentence or paragraph format. There is another assignable cause drop-down input for a defect category indicated by numeral 560 and a remedial action category drop-down input indicated by numeral 562. There is a click-on input 566 for indicating that it is an active assignable cause for a defect. The user then clicks on a “save” graphical user interface pushbutton 568 to save the assignable cause information with the use of a userid and a personal identification number (PIN), as previously described. There is also a “new” graphical user interface pushbutton 564 to clear the assignable cause information so that new assignable cause information can be inputted.

Virtually any type of machinery used in either manufacturing or service processes can be considered a device. It is helpful to be able to categorize devices by manufacturer and model.

Devices can include a myriad of machines including processors, e.g., pocket processors, temperature probes, sensors, and so forth, utilized in manufacturing or service operations. It is helpful to categorize the devices by types. The first step in this process is to perform the previously described “login” function and select a “measuring devices” page screen from a maintenance facility, e.g., plant, explorer graphical user interface screen. The “measuring devices” page on the maintenance facility, e.g., plant, explorer graphical user interface screen is then displayed, as shown in FIG. 26, which is generally indicated by numeral 570. This is the first step in categorizing the manufacturers of devices. There is a graphical user interface pushbutton 574 for inputting a new device type, a graphical user interface pushbutton 576 for inputting a new manufacturer, a graphical user interface pushbutton 578 for inputting a new model, and a graphical user interface pushbutton 580 for inputting a new device. Moreover, there is a graphical user interface pushbutton 582 for editing the previously entered device types, manufacturers, models and devices.

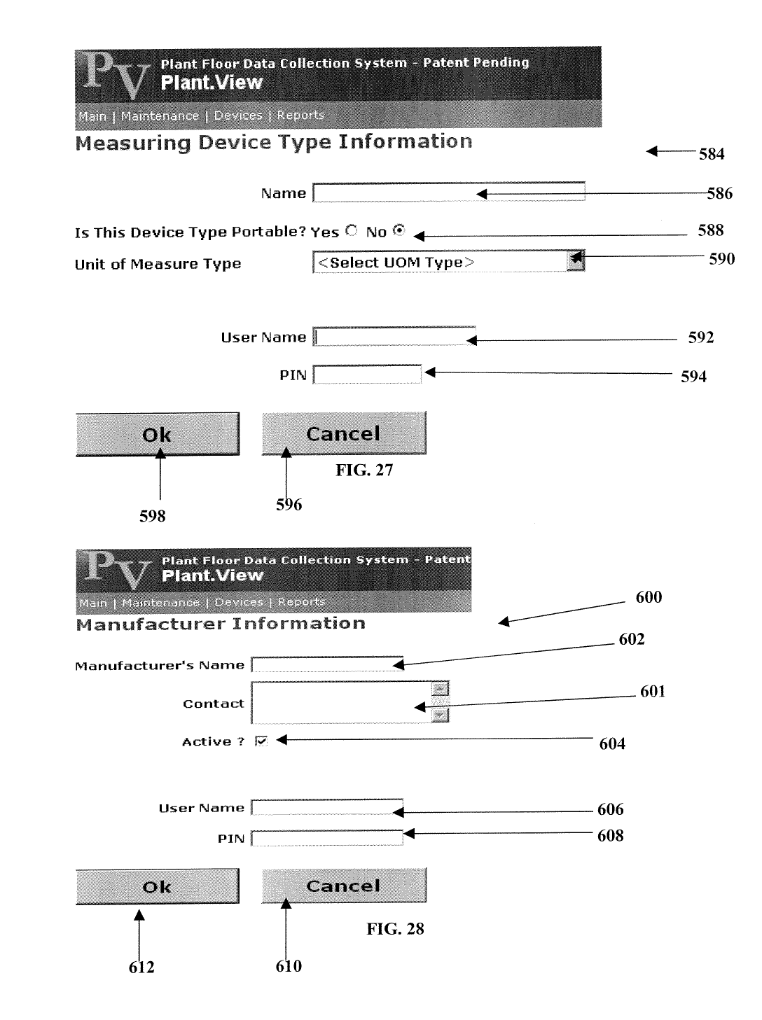

The “measuring device type information” page on the maintenance facility, e.g., plant, explorer graphical user interface screen is then displayed, as shown in FIG. 27, which is generally indicated by numeral 584, which can be accessed from the graphical user interface pushbutton 574 for inputting a new device type, as shown in FIG. 26. The new device type information that can be provided includes the name of a device in an input 586 and a click-on input for whether or not a particular device type is portable 588. There is a drop-down input 590 to provide a unit of measure for a device type. The user then clicks on an “ok” graphical user interface pushbutton 598 to save the information with the use of a userid through input 592 and a personal identification number (PIN) through input 594, as previously described. There is also a “cancel” graphical user interface pushbutton 596 to clear the type of device type information so that new device type information can be inputted. The new or updated name for a manufacturer, a description of the manufacturer and an indication as to whether the type of test is active, then appears on an output screen as indicated by numeral 572 in FIG. 26. A specific device can be added or updated in the same manner as other previously described features are added or updated on the system.

The manufacturer information on the maintenance facility, e.g., plant, explorer graphical user interface screen is then displayed, as shown in FIG. 28, which is generally indicated by numeral 600, which can be accessed from the graphical user interface pushbutton 576 for inputting a new manufacturer, as shown in FIG. 26. The name of a manufacturer can be provided in an input 602. The contact information for the manufacturer for a device can be typed-in through an input 601 that allows verbiage to be provided in sentence or paragraph format. There is a click-on input 604 for indicating that it is an active manufacturer for a device. The user then clicks on an “ok” graphical user interface pushbutton 612 to save the information with the use of a userid through input 606 and a personal identification number (PIN) through input 608, as previously described. There is also a “cancel” graphical user interface pushbutton 610 to clear the type of device type information so that new device type information can be inputted. The new or updated name for a manufacturer, a description of the manufacturer and an indication as to whether the type of test is active, then appears on an output screen as indicated by numeral 572 in FIG. 26.

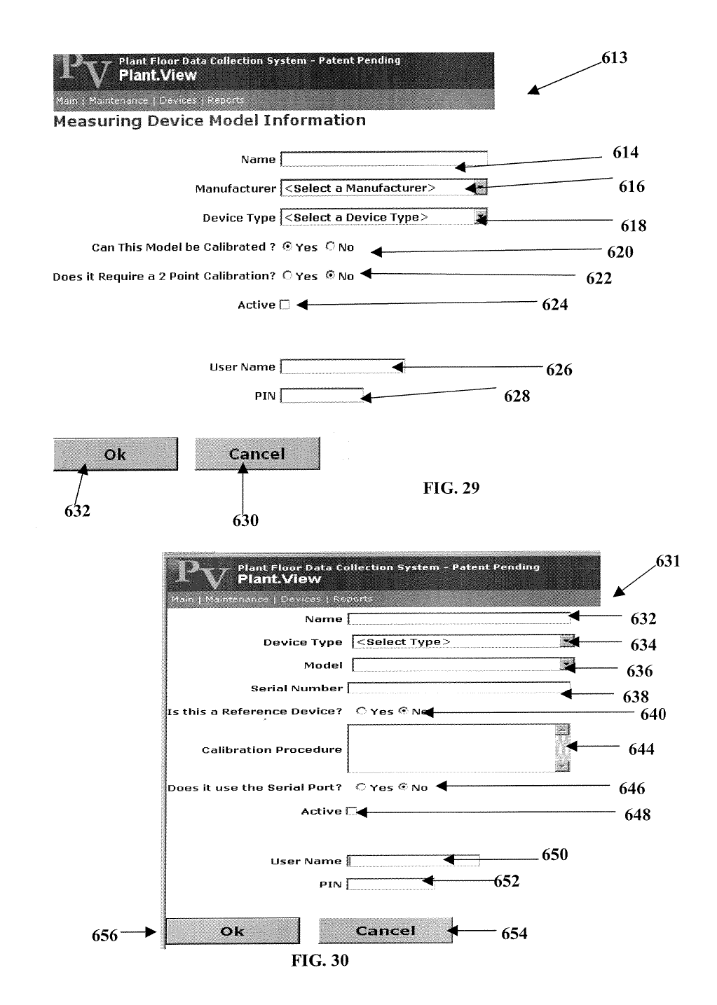

The measuring device model information on the maintenance facility, e.g., plant, explorer graphical user interface screen is then displayed, as shown in FIG. 29, which is generally indicated by numeral 613, which can be accessed from the graphical user interface pushbutton 578 for inputting a new device model, as shown in FIG. 26. The model information that can be provided includes the name of a model in an input 614, a name of a manufacturer in drop-down input 616 and a type of device in drop-down input 618. There is a click-on input for whether or not a particular model can be calibrated in the system 620. There is a click-on input for whether or not a particular model requires a 2 point calibration in the system 622 and a click-on input 624 for indicating that it is an active device model. The user then clicks on an “ok” graphical user interface pushbutton 632 to save the information with the use of a userid through input 626 and a personal identification number (PIN) through input 652, as previously described. There is also a “cancel” graphical user interface pushbutton 630 to clear the type of model information so that new model information can be inputted.

The measuring device model information on the maintenance facility, e.g., plant, explorer graphical user interface screen is then displayed, as shown in FIG. 30, which is generally indicated by numeral 631, which can be accessed from the graphical user interface pushbutton 580 for inputting a new device, as shown in FIG. 26. Here, the specific device can also be added or updated on the system. Illustrative examples of the type of device information that can be inputted includes a device name 632, a drop-down input for a manufacturer 634, a drop-down input for a model 636, an input for a serial number 638. There is a click-on input for whether or not a particular device is a reference device for calibration in the system 640. The calibration procedure can be typed-in through an input 644 that allows verbiage to be provided in sentence or paragraph format. A click-on input for whether the device uses a serial port 646 and a click-on input for whether the device is active 648. The user then clicks on an “ok” graphical user interface pushbutton 656 to save the information with the use of a userid through input 650 and a personal identification number (PIN) though input 652, as previously described. There is also a “cancel” graphical user interface pushbutton 654 to clear the type of device information so that new device information can be inputted. The new or updated name for the device then appears on an output screen as indicated by numeral 572 in FIG. 26. A device type can be added or updated in the same manner as other previously described features are added or updated on the system.

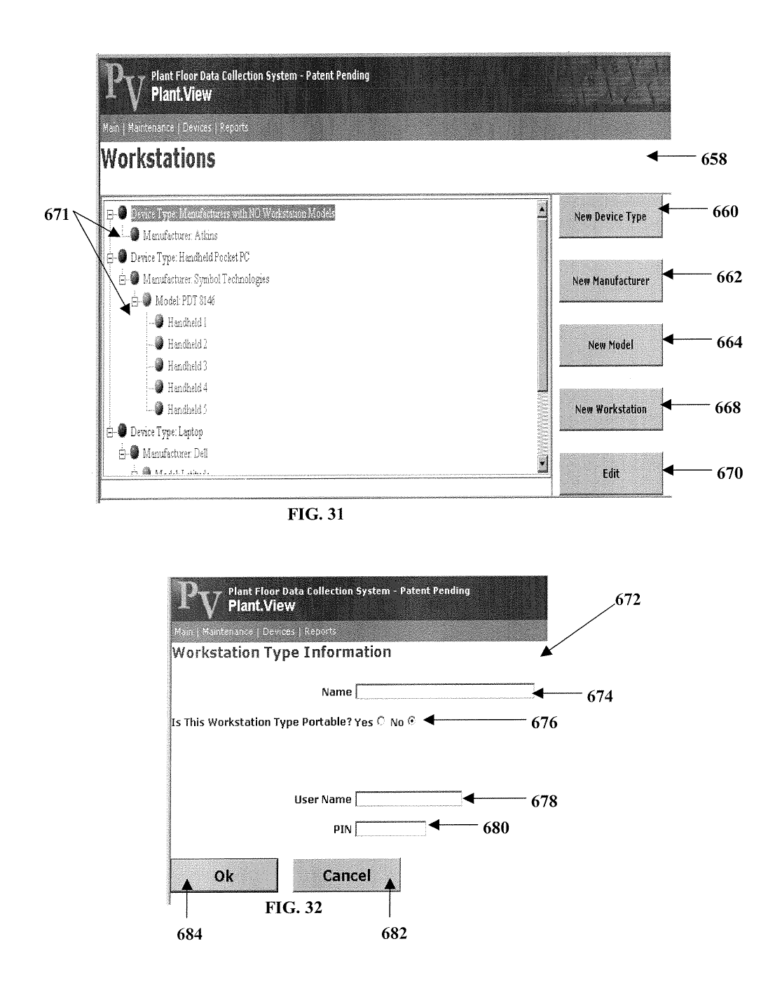

Workstations can include a myriad of machines including processors, e.g., pocket processors, industrial computers, personal computers (PCs), and so forth, utilized in manufacturing or service operations. It is helpful to categorize the workstations by types. The first step in this process is to perform the previously described “login” function and select a “workstations” page screen from a maintenance graphical user interface screen. The “workstations” page on the maintenance facility, e.g., plant, explorer graphical user interface screen is then displayed, as shown in FIG. 31, which is generally indicated by numeral 658. A variety of processors can be added or removed from the system as shown on the “workstations” page on the maintenance facility, e.g., plant, explorer graphical user interface screen 671 is then displayed. There is a graphical user interface pushbutton 660 for inputting a new device type, a graphical user interface pushbutton 662 for inputting a new manufacturer, a graphical user interface pushbutton 664 for inputting a new model of workstation, and a graphical user interface pushbutton 668 for inputting a new workstation. Moreover, there is a graphical user interface pushbutton 670 for editing the previously entered device types, manufacturers, models and workstations.

The workstation type information can be provided on the maintenance facility, e.g., plant, explorer graphical user interface screen is then displayed, as shown in FIG. 32, which is generally indicated by numeral 672, which can be accessed from the graphical user interface pushbutton 668 for inputting a new device, as shown in FIG. 31. Illustrative examples of the type of workstation type information that can be inputted includes a device type name 674, a click-on input for whether the workstation type or processor is portable 676. The user then clicks on an “ok” graphical user interface pushbutton 684 to save the information with the use of a userid through input 678 and a personal identification number (PIN) through input 680, as previously described. There is also a “cancel” graphical user interface pushbutton 682 to clear the type of workstation information so that new device type information can be inputted. The new or updated name for a workstation type, a description of the workstation type then appears on an output screen as indicated by numeral 671 in FIG. 3 1. A workstation type can be added or updated in the same manner as other previously described features are added or updated on the system.

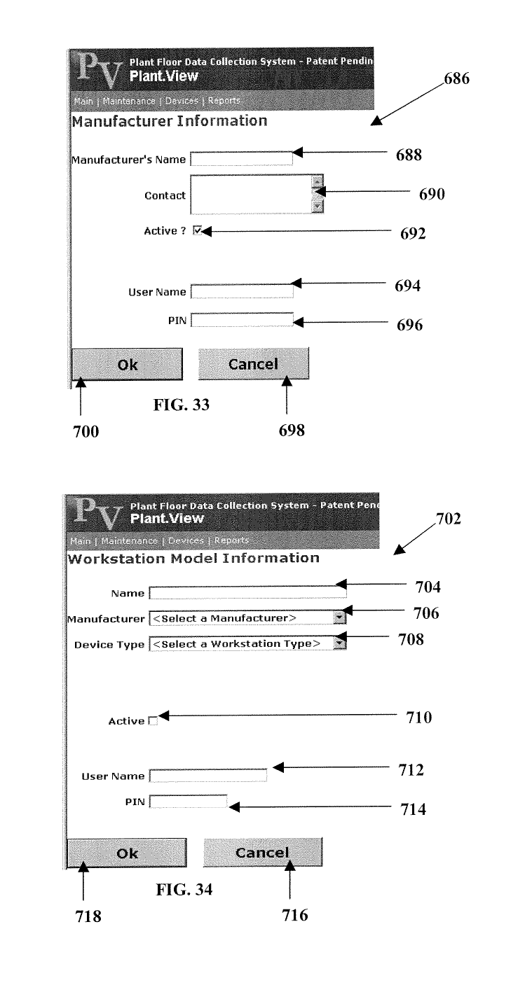

The manufacturer information can be provided on the maintenance facility, e.g., plant, explorer graphical user interface screen is then displayed, as shown in FIG. 33, which is generally indicated by numeral 686, which can be accessed from the graphical user interface pushbutton 662 for inputting a new manufacturer, as shown in FIG. 31. The name of the manufacturer for a workstation can be typed-in through an input 688. The primary contact information for the manufacturer can be provided in input 690 that allows verbiage to be provided in sentence or paragraph format. There is a click-on input 692 for indicating that it is an active manufacturer for a workstation. The user then clicks on an “ok” graphical user interface pushbutton 700 to save the information with the use of a user id through input 694 and a personal identification number (PIN) through input 696, as previously described. There is also a “cancel” graphical user interface pushbutton 698 to clear the type of manufacturer information so that new manufacturer information can be inputted.

The workstation model information can be provided on the maintenance facility, e.g., plant, explorer graphical user interface screen is then displayed, as shown in FIG. 34, which is generally indicated by numeral 702, which can be accessed from the graphical user interface pushbutton 664 for inputting a new workstation model, as shown in FIG. 31. The model information that can be provided includes the name of a model in an input 704, a name of a manufacturer in drop-down input 706 and a type of device in drop-down input 708. There is a click-on input 710 for indicating that it is an active workstation model. The user then clicks on an “ok” graphical user interface pushbutton 718 to save the information with the use of a user id through input 712 and a personal identification number (PIN) through input 714, as previously described. There is also a “cancel” graphical user interface pushbutton 716 to clear the type of model information so that new model information can be inputted.

A specific workstation can also be added or updated on the system on the maintenance facility, e.g., plant, explorer graphical user interface screen is then displayed on a “workstation information” page, as shown in FIG. 35, which is generally indicated by numeral 720, which can be accessed from the graphical user interface pushbutton 668 for inputting a new workstation model, as shown in FIG. 31. Illustrative examples of the type of workstation information that can be inputted includes a workstation name 722, a drop-down input for a device type 724, a drop-down input for a model 726, an input for a serial number 728 and a click-on input for whether the device is active 730. The user then clicks on an “ok” graphical user interface pushbutton 738 to save the information with the use of a user id through input 732 and a personal identification number (PIN) through input 734, as previously described. There is also a “cancel” graphical user interface pushbutton 736 to clear the type of workstation information so that new workstation information can be inputted. The new or updated name for the workstation then appears on an output screen as indicated by numeral 671 in FIG. 31. A workstation can be added or updated in the same manner as other previously described features are added or updated on the system.

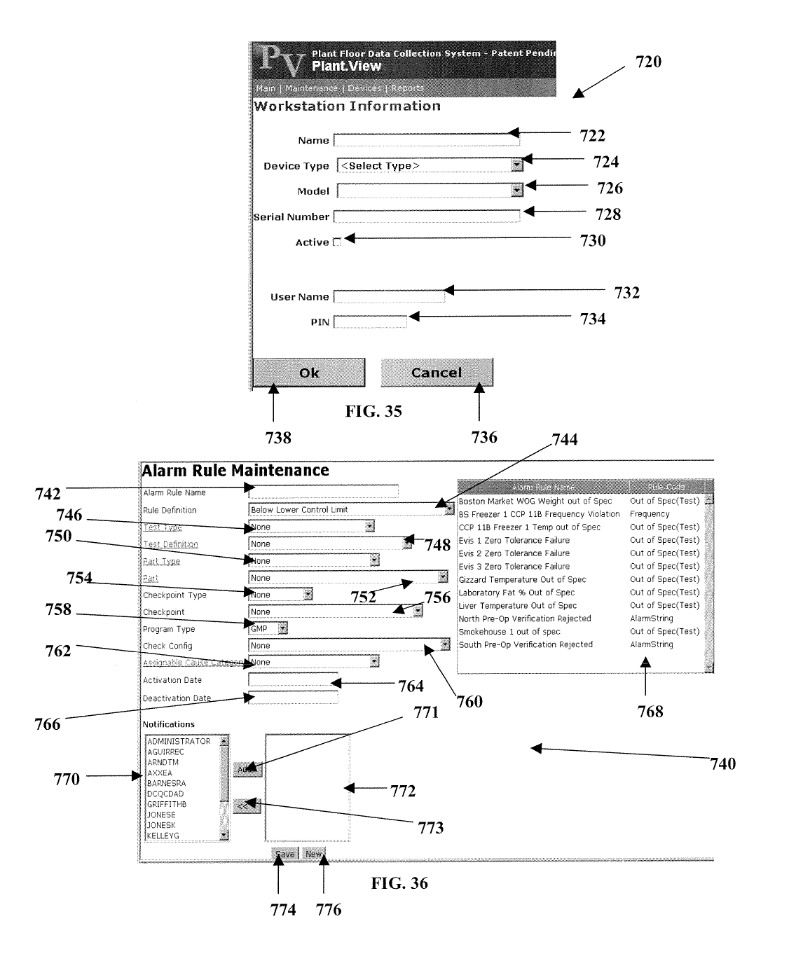

A major feature of the present invention is the ability to set alarms. These can include pagers, phone calls, including cellular, and so to notify users when a check falls out of specification. Referring now to FIG. 36, an alarm can also be added or updated on the system. The “alarm rule” page on the maintenance facility, e.g., plant, explorer graphical user interface screen 740 is then displayed. Illustrative examples of the type of alarm information that can be inputted includes an alarm rule name 742, a drop-down input for an alarm rule definition 744, a drop-down input for a test type 746, a drop-down input for a test definition 748, a drop-down input for a part type 750, a drop-down input for a part 752, a drop-down input for a checkpoint type 754, a drop-down input for a checkpoint 756, a drop-down input for a program type 758, a drop-down input for a check configuration 760, a drop-down input for an assignable cause category 762, an activation date input 764, a deactivation date input 766. There is a listing of all individuals or entities that can receive an alarm 770. By clicking on an “add” graphical user pushbutton 771, individuals or entities can be added to a listing 772. There is another graphical user pushbutton 773 for removing individuals or entities from the listing 772. The user then clicks on an “save” graphical user interface pushbutton 774 to save the information with the use of a user id and a personal identification number (PIN), as previously described. There is also a “new” graphical user interface pushbutton 776 to clear the type of alarm rule information so that new alarm rule information can be inputted. The alarm rule and rule code then appear on an output screen as indicated by numeral 768.

A major feature of the present invention is a portion of the software that is entitled facility, e.g., plant, explorer that allows the user to add, eliminate or update departments, lines, processes and regulatory descriptions of potential hazards, e.g., critical control points (“CCP”) biological, chemical and physical hazards.

The first step in this process is to perform the previously described “login” function <202> and select a facility, e.g., plant, explorer graphical user interface screen <204>, as shown in FIG. 8. The facility, e.g., plant, explorer graphical user interface screen is then displayed, as shown in FIG. 13 and generally indicated by numeral 342. The user then selects the department or line that has a checkpoint that is being created <206>, as shown in FIG. 8. Exemplary departments are indicated by numeral 332 and exemplary lines are indicated by numeral 334 in a logical tree, as shown in FIG. 13. There is a graphical user interface pushbutton 330 that can filter the listing of items in the logical tree 334. Also, there is a listing of parts 1201 that can include a start date and time 1203, a finish date and time 1205, a shift number 1207, a user identification 1209, an indication as to whether the part is disabled 12011 and a status indication, e.g., complete, 1213. The parts can be selected through a started after date input 338 and a started before date input 340 with a graphical user pushbutton 336 to apply these before and after dates.

The user clicks on a parent in a tree and then clicks on adding a “new check configuration” from a menu <208> and then the “general information” is clicked on and then a graphical user interface button for save <210> is then clicked, as shown in FIG. 8. This can include a check name, check description, activation date, deactivation date, lot tracking, allowed interruption due to shift and complete check with associated time.

A previously configured group part can be clicked-on and fields inputted such as the part type, product description, a right arrow to move product description to a selected pane and then a graphical user interface button for save <212> is then clicked. A data providing role can also be defined such a collection and/or verification roles. Arrows can be used to select collection and/or verifier roles and move to the appropriate pane. The data collection roles are then saved when a graphical user interface button <214> is then clicked.

The user can then perform a right click, a “check configuration,” from a menu and then the “add a sample set” is then selected. A program type, sample size, variable sample size, complete sample required, pre-shipment review, monitor procedure, and verification procedure, can be selected and then a graphical user interface button for save <216> is then clicked, as shown in FIG. 8.

The user can then perform a right click, a “sample set,” from a menu and then the “add a test” is then selected. A critical control point (CCP), test type, test definition, data source, device type, label description, numeric rounding and charting, can be selected and then a graphical user interface button for save <218> is then clicked, as shown in FIG. 8.

The entire configuration can then be saved by clicking on a “save button” in the top right hand corner <220>, is then clicked, as shown in FIG. 8. As previously described, a user identification name (userid) and a personal identification number (PIN) is required.

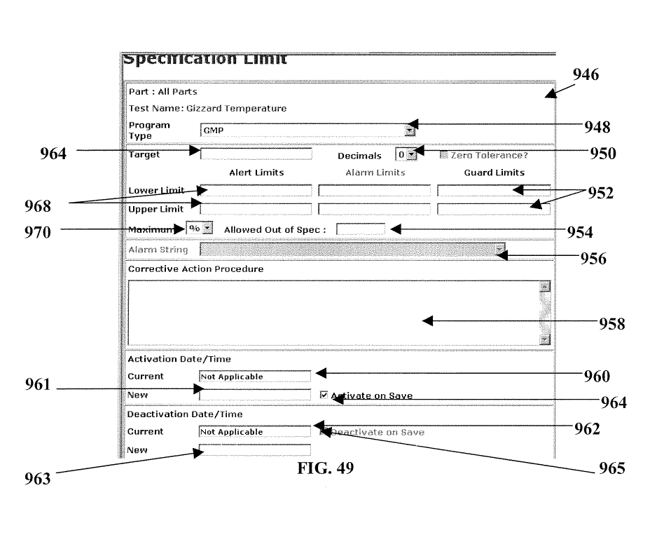

Specification limits can be organized so that these items in the system can be readily retrieved. The first step in organizing types of remedial action is to select a “spec” age screen on the maintenance facility, e.g., plant, explorer graphical user interface screen is then displayed, as shown in FIG. 49, which is generally indicated by numeral 946. There is a drop-down input 948 to provide a program for a type of specification limit. The target limit of the specification limit can be labeled through input 964. There is a drop-down input 950 to provide a decimal limit for the specification limit and the lower and upper limits can be labeled through input numerals 952 and 968. There is a drop-down input 970 to provide a maximum percentage or number of samples and the number of allowed can be labeled through input 954 for the specification limit. The description of the corrective action procedure can be typed-in through an input 958 that allows verbiage to be provided in sentence or paragraph format. There is a current activation date and time indicated by numeral 960 and an input for a new activation date and time indicated by numeral 961. There is a click-on input 964 for indicating that it is an active specification limit. There is a deactivation date and time indicated by numeral 962 and an input for a new deactivation date and time indicated by numeral 963. There is a click-on input 965 for indicating that it is a deactivation specification limit upon save. The user then clicks on a “save” graphical user interface pushbutton (not shown) to save the specification limit information with the use of a user id and a personal identification number (PIN), as previously described.

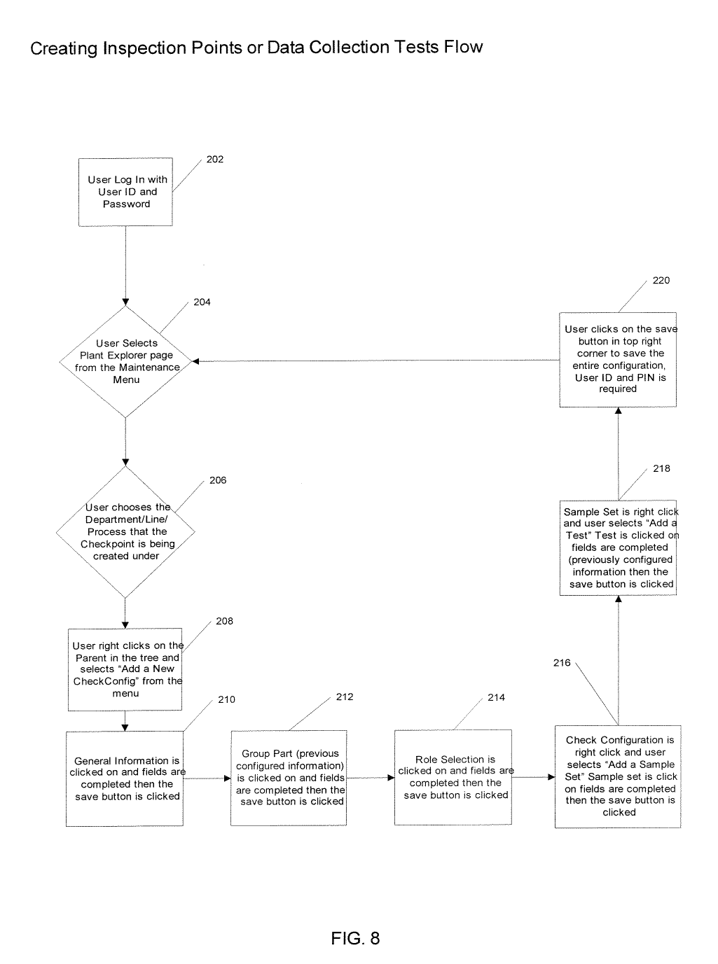

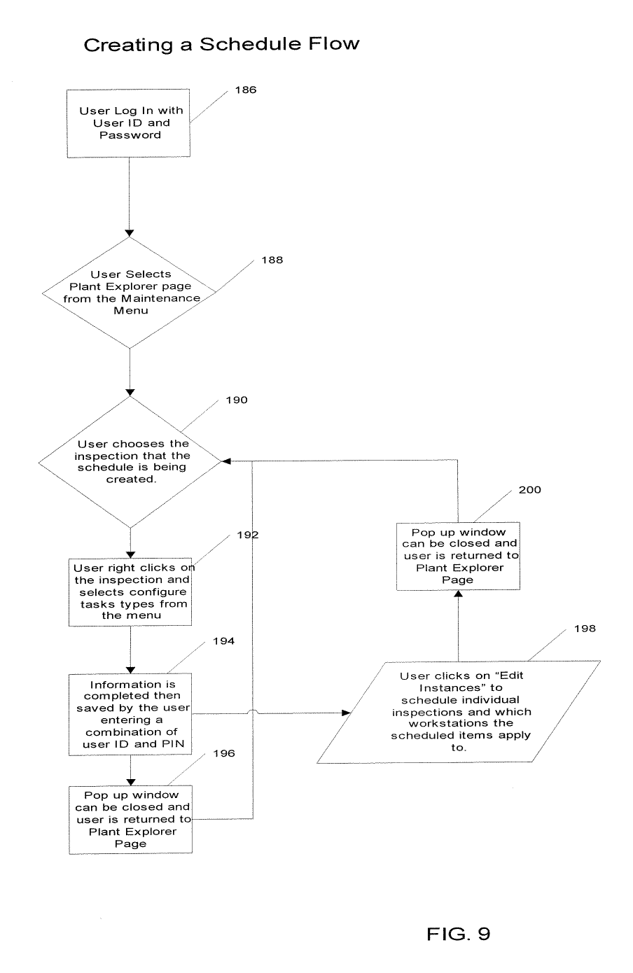

As shown in FIG. 9, the next step in the process is to create a schedule. The first step in this process is to perform the previously described “login” function <186> and select a facility, e.g., plant, explorer graphical user interface screen <188>, as shown in FIG. 9. The user then chooses the inspection for the schedule that is being created <190>. The user then right clicks on the inspection and selects configure task types from a menu <192>. The information is then completed and saved by the user by entering a combination of user identification name (userid) and a personal identification number (PIN) <194>. Then the user can close the pop-up window and return to the facility, e.g., plant explorer page <196> and return to step <190> to choose the inspection for the schedule that is being created. In the alternative, the user can click-on “Edit Instances” to schedule individual inspections and determine which workstations and scheduled items the schedule is applied <198>. Then the user can close the pop-up window and return to the facility, e.g., plant explorer page <200> and then the user returns to step <190> to choose the inspection for the schedule that is being created.

There are very specific controls that prevent the editing of data. Only a very select number of authorized users can alter data on some reports. There must always be a reason provided for changing or editing data that is electronically signed by the user. Data verification can occur at a plant, department, line or process level. It is possible to clone checkpoint settings.

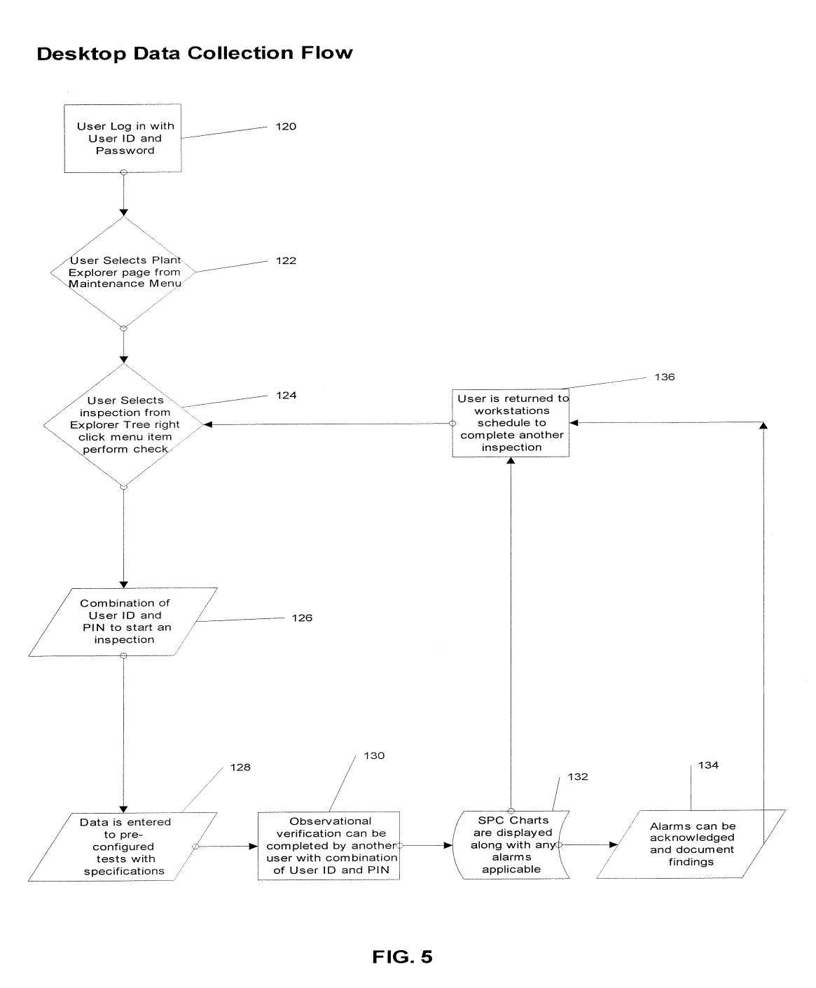

Data collection is very similar for either hand-held pocket processors that transmit by radio frequency or a desktop-type processor. The first step is to perform the previously described “login” function <100> and <120>, respectively as shown on FIGS. 4 and 5. The next step is to select a workstation identification number if using the hand-held pocket processor <102>, as shown in FIG. 4, or select a facility, e.g., plant, explorer graphical user interface screen <122>, as shown in FIG. 5. This is followed by selecting displaying a workstation schedule if using the hand-held pocket processor <104>, as shown in FIG. 4. This is followed by selecting a inspection from the facility from scheduled or on-demand items using either the hand-held pocket processor <106>, as shown in FIG. 4 or the facility, e.g., plant, explorer graphical user interface screen <124>, as shown in FIG. 5. A combination of user identification name (userid) and personal identification number (PIN) is used to start an inspection <108> and <126>, as shown on FIGS. 4 and 5, respectively. Data is then entered to preconfigured tests with specifications <110> and <128>, as shown on FIGS. 4 and 5, respectively. Observational verification of the entered data can be completed by another user with a combination of inputted user id and password <112> and <130>, as shown on FIGS. 4 and 5, respectively. Statistical process control charts are then displayed with applicable alarms <114> and <132>, as shown on FIGS. 4 and 5, respectively. The next step in the process is to acknowledge the alarms and document the findings <116> and <134>, as shown on FIGS. 4 and 5, respectively. Finally, the user is returned to the schedule for the workstations to complete another inspection <118> and <136>, as shown on FIGS. 4 and 5, respectively. The system then returns to selecting a inspection from the facility from scheduled or on-demand items using either the hand-held pocket processor <106>, as shown in FIG. 4 or the facility, e.g., plant, explorer graphical user interface screen <124>, as shown in FIG. 5.

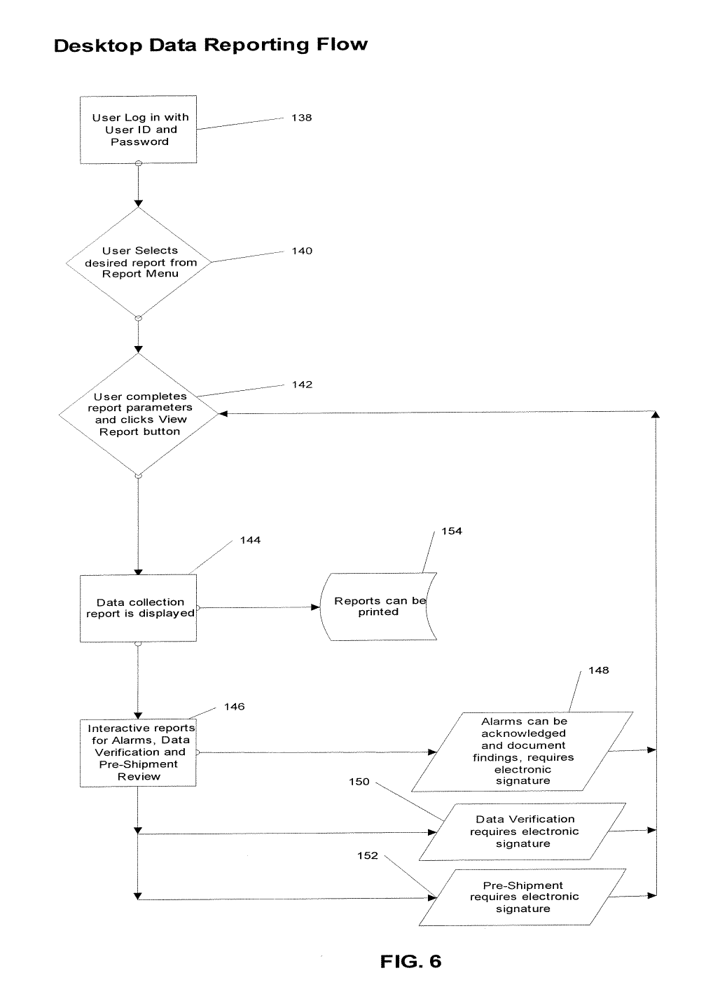

Another main feature of the present invention is to provide reporting capability. As shown in FIG. 6, the first step is to perform the previously described “login” function <138>. This is then followed by selecting the desired reports from the reports menu <140>. The user then completes the report parameters and then clicks a view report graphical interface pushbutton <142>. A data collection report is then displayed <144> and then reports can be printed <154>. In the alternative, after the data collection report is then displayed <144>, then interactive reports can require electronic signatures. The alarms can then be acknowledged with the document finding requiring electronic signature as previously described <148>. Also, the data verification will require electronic signature <150>. Moreover, the pre-shipment review will require an electronic signature <152>. The process then returns to step <142>, which is to have the user select the desired reports from the reports menu.

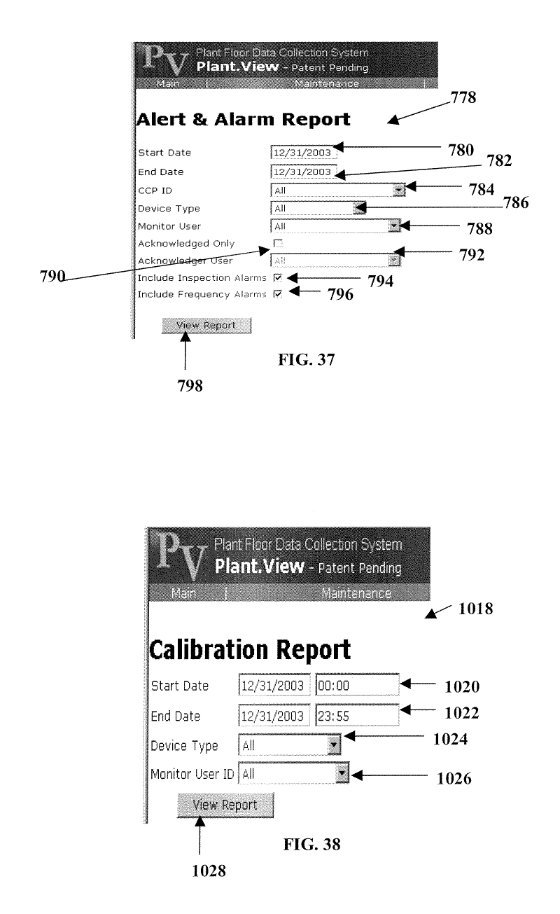

These reports include an alert and alarm report shown on FIG. 37 with a graphical user interface screen indicated by numeral 778. This includes a start date input 780, end date input 782, CCP identification drop-down input 784, device type drop-down input 786, monitor user drop-down input 788, acknowledged only click-on input 790, and acknowledged user drop-down input 792. There is also a click-on input to include inspection alarms 794 and a click-on input to include frequency alarms 796. There is a graphical user pushbutton 798 that allows the user to view the report.

There is a calibration report shown on FIG. 38 with a graphical user interface screen indicated by numeral 1018. There is a start date and time 1020, end date and time 1022, a drop-down input for a device type 1024 and a drop-down input for a monitor user identification 1026. There is a graphical user pushbutton 1028 that allows the user to view the report.

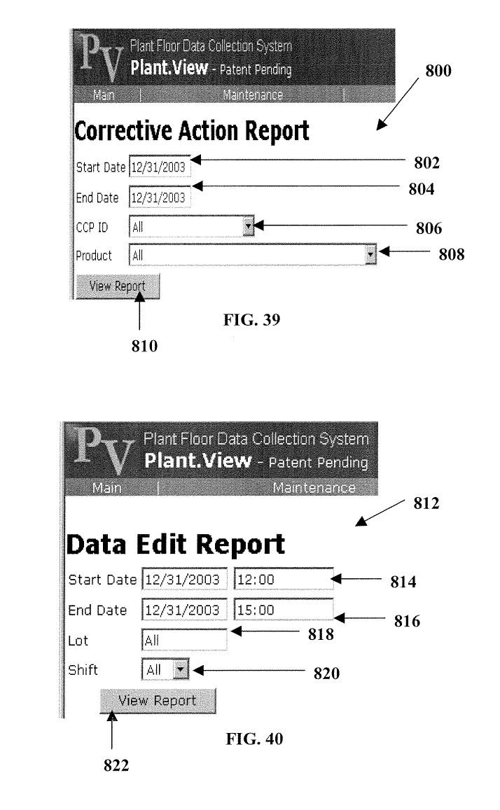

There is a corrective action report shown on FIG. 39 with a graphical user interface screen indicated by numeral 800. There is a start date input 802, end date input 804, drop-down input for CCP identification 806, and a drop-down input for a product selection 808. There is a graphical user pushbutton 810 that allows the user to view the report.

A data edit report is shown on FIG. 40 with a graphical user interface screen indicated by numeral 812. There is a start date and time input 814, an end date and time input 816, a lot input 818 and a drop-down input for the shift 820. There is a graphical user pushbutton 822 that allows the user to view the report.

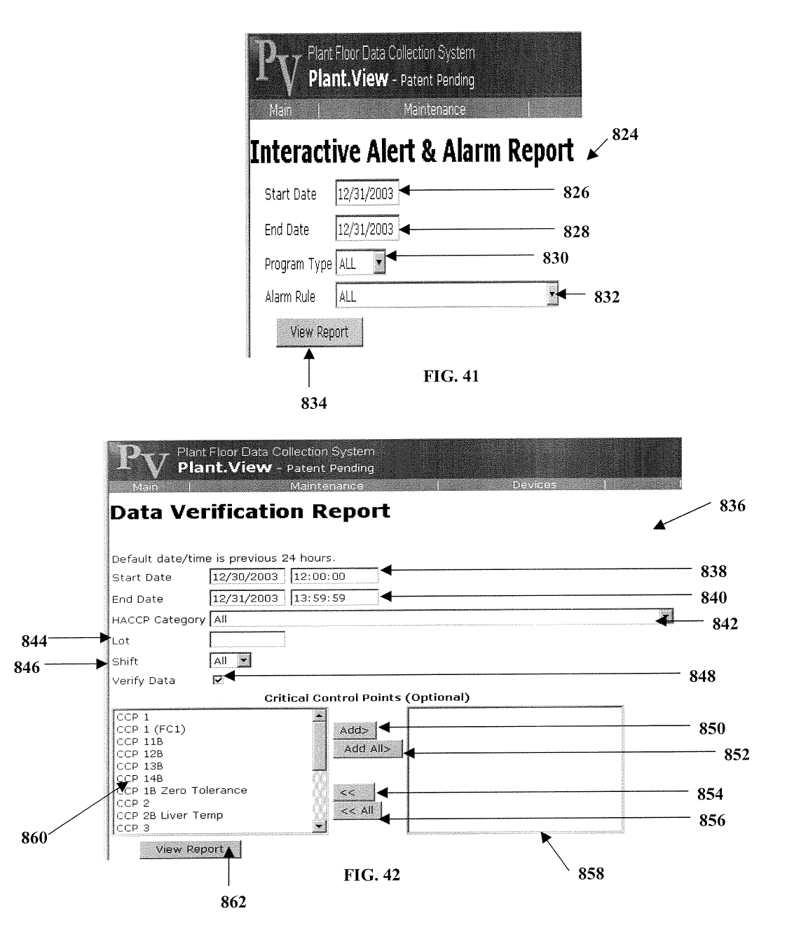

There is an interactive alert and alarm report shown on FIG. 41 with a graphical user interface screen indicated by numeral 824. There is a start date input 826, an end date input 828, a drop-down input for a program type 830 and a drop-down input for an alarm rule 832. There is a graphical user pushbutton 834 that allows the user to view the report.

There is a pre-shipment review report is shown on FIG. 44 with a graphical user interface screen indicated by numeral 876. There is a start date and time input 878, an end date and time input 880, a drop-down input for a program type 882, a drop-down input for a CCP identification 884, a drop-down input for a HCCP category 886, an input for a lot 888, and a drop-down input for a shift 890. There is a selection of click-on inputs for a preshipment review mode including: a pre-shipment review 892; a summary of reviewed checks 894; details of reviewed checks 896; and details regarding all checks 898. There is a graphical user pushbutton 900 that allows the user to view the report.

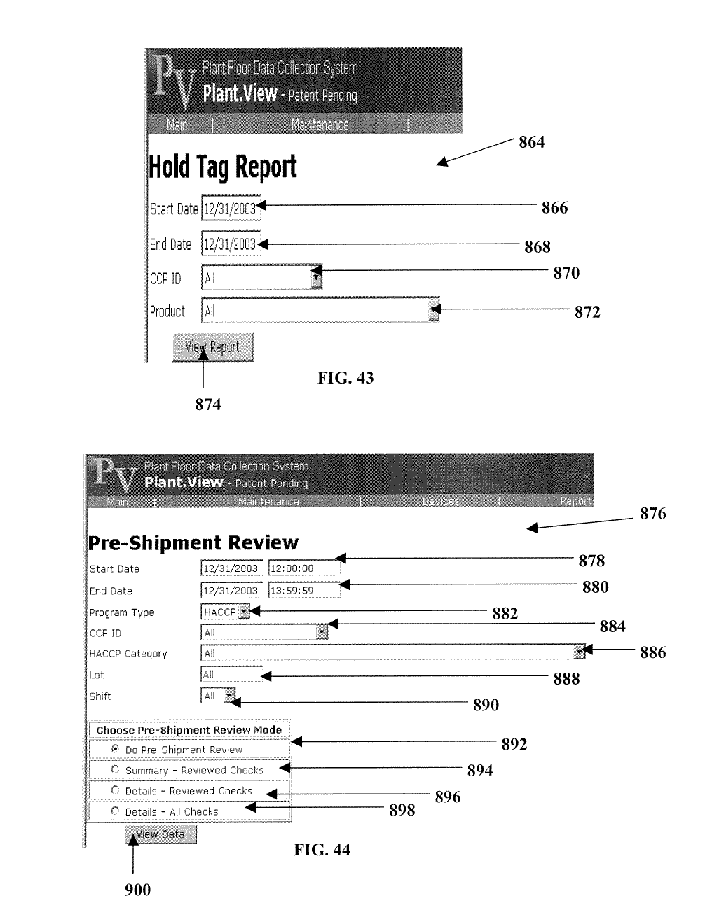

There is a hold tag report is shown on FIG. 43 with a graphical user interface screen indicated by numeral 864. There is a start date input 866, an end date input 868, a drop-down input for CCP identification 870, and a drop-down input for the product 872. There is a graphical user pushbutton 874 that allows the user to view the report.

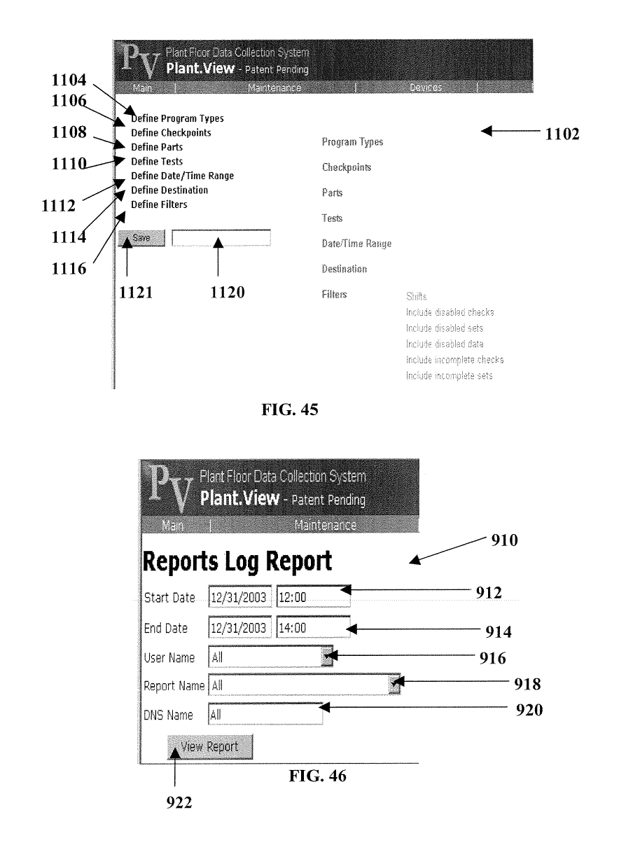

A query report and export function is shown on FIG. 45 and indicated by numeral 1102. This includes a function to define and save program types 1104, define checkpoints 1106, define parts 1108, define tests 1110, define a date and/or time range 1112, define destination 1114 and define filters 1116. There is an input for identifying the defined item 1120 and a graphical user pushbutton 1121 to save it.

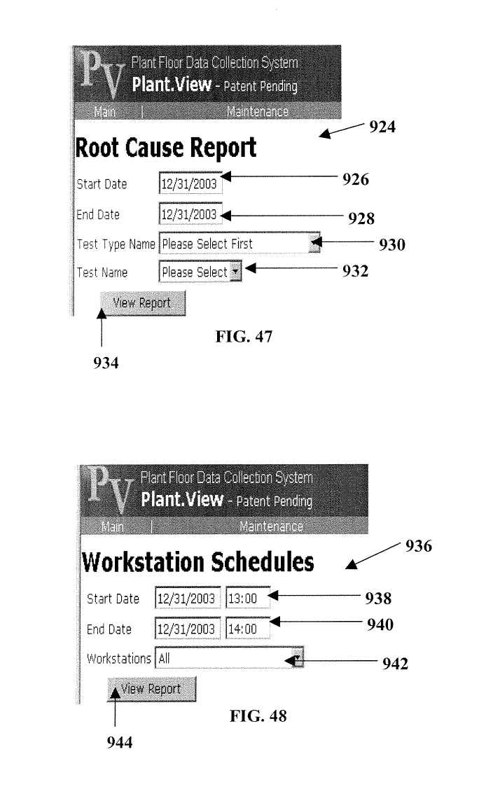

There is a root cause report that is shown on FIG. 47 with a graphical user interface screen indicated by numeral 924. There is a start date input 926, an end date input 928, a drop-down input for a test type name 930, and a drop-down input for a test name 932. There is a graphical user pushbutton 934 that allows the user to view the report.

There is a workstation schedule report that is shown on FIG. 48 with a graphical user interface screen indicated by numeral 936. There is an input for a start date and time 938, an input for an end date and time 940, and a drop-down input for the selected workstations 942. There is a graphical user pushbutton 944 that allows the user to view the report.

There is a reports log report that is shown on FIG. 46 with a graphical user interface screen indicated by numeral 910. There is an input for a start date and time 912, an input for an end date and time 914, a drop-down input for a user name 916, a drop-down input for a report name 918 and an input for a domain name system (DNS) name. The domain name system is the mechanism where Internet domain names are located and translated into IP (Internet Protocol) addresses. A domain name is a meaningful and easy-to-remember “handle” for an Internet address. There is a graphical user pushbutton 922 that allows the user to view the report.

There is a data verification report that is shown on FIG. 42 with a graphical user interface screen indicated by numeral 836. There is an input for a start date and time 838, an input for an end date and time 840, a drop-down input for a HACCP category 842, an input for a particular lot 844, a drop-down input for a particular shift 846 and a click-on input to obtain a verification of the data. Selected critical control points can be included on a data verification report. A complete listing of all critical control points is displayed in a first column that is generally indicated by numeral 860. The desired critical control points can be selected via an “add” graphical user interface pushbutton 850 to move the highlighted critical control point from the first column 860 to a second column that is generally indicated by numeral 858. All of the critical control points can be selected via an “add all” graphical user interface pushbutton 852 to move the highlighted critical control point from the first column 860 to the second column 858. Selected critical control points can be removed from the second column 858 and returned to the first column 860 via an “<<” graphical user interface pushbutton 854. Moreover, all of the critical control points can be removed from the second column 858 and returned to the first column 860 via an “<<All” graphical user interface pushbutton 854. There is a graphical user pushbutton 862 that allows the user to view the report.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

1. A method for monitoring facility data utilizing a computer system comprising:
inputting information relating to at least one part from at least one input device into the computer system;
inputting information relating to at least one field from the at least one input device into the computer system; and
inputting measurement data from a plurality of measurement devices, wherein the inputted measurement data is at least partially correlated to the information related to the at least one part and the information related to the at least one field.

2. The method for monitoring facility data utilizing a computer system as set forth in claim 1, wherein the inputting information relating to the at least one part includes inputting least one part type and inputting at least one specific part and the inputting information relating to the at least one field includes inputting at least one field type and inputting at least one specific field.

3. The method for monitoring facility data utilizing a computer system as set forth in claim 1, further comprises inputting information relating to at least one facility into the computer system.

4. The method for monitoring facility data utilizing a computer system as set forth in claim 2, wherein the at least one part type is selected from the group consisting of types of components of products, types of subassemblies of products, types of fully assembled products, types of manufacturing machines, and types of processing machines.

5. The method for monitoring facility data utilizing a computer system as set forth in claim 2, wherein the at least one specific part includes information that is selected from the group consisting of at least one part name, at least one part type, at least one product code, at least one brand code, at least one regulatory category, at least one Hazard Analysis and Critical Control Point category and at least one product characteristic information.

6. The method for monitoring facility data utilizing a computer system as set forth in claim 2, wherein the at least one field group is selected from the group consisting of bone types, zero tolerance items, reprocessed zero tolerance items, salvaged zero tolerance items, fecal contamination locations, sanitation standard operating procedures (SSOP) ratings and work-in-progress temperatures

7. The method for monitoring facility data utilizing a computer system as set forth in claim 1, wherein the inputting measurement data from a plurality of measurement devices includes inputting at least one type of unit of measurement.

8. The method for monitoring facility data utilizing a computer system as set forth in claim 7, wherein the at least one type of unit of measurement is selected from the group consisting of weight, count, temperature, percentage, string data, date, time, proportion, measurement, speed, pressure and length of time.

9. The method for monitoring facility data utilizing a computer system as set forth in claim 1, wherein the inputting measurement data from a plurality of measurement devices includes inputting at least one specific unit of measurement.

10. The method for monitoring facility data utilizing a computer system as set forth in claim 1, wherein the inputting measurement data from a plurality of measurement devices includes inputting at least one type of test.

11. The method for monitoring facility data utilizing a computer system as set forth in claim 1, wherein the inputting measurement data from a plurality of measurement devices includes at least one specific test.

12. The method for monitoring facility data utilizing a computer system as set forth in claim 10, wherein the at least one type of test is selected from the group consisting of a temperature of a product at a particular point in processing, inspection for fecal contamination, weight of the product, percentage of trisodium phosphate solution, verification of critical limits, pre-shipment verification of product quality, thermometer calibration with comparison against NST certified standard weight and visual inspections regarding sanitation.

13. The method for monitoring facility data utilizing a computer system as set forth in claim 1, wherein the inputting measurement data from a plurality of measurement devices includes inputting information selected from the group consisting of at least one type of measurement device, at least one manufacturer of a measurement device, at least one model of measurement device and at least one specific measurement device.

14. The method for monitoring facility data utilizing a computer system as set forth in claim 13, wherein the inputting information relating to at least one type of measurement device is selected from the group consisting of at least one name of a measurement device type, at least one indication as to whether a measurement device type is portable, at least one unit of measurement for a measurement device type, at least one name of a manufacturer of a measurement device, contact information for a manufacturer of a measurement device, at least one indication as to whether a manufacturer of a measurement device is active, at least one name of a measurement device model, at least one manufacturer of a measurement device model, at least one type of measurement device model, at least one indication as to whether a measurement device model requires calibration, at least one indication as to whether a model of measurement device model requires two-point calibration, at least one indication as to whether at least one model of measurement device is active, at least one name of a specific measurement device, at least one type for a specific measurement device, at least one serial number for a specific manufacturing device, at least one indication of whether a specific measurement device is a reference device, at least one calibration procedure for a specific measurement device, at least one indication as to whether a serial port is utilized for a specific measurement device and at least one indication as to whether or not a specific measurement device is active.

15. The method for monitoring facility data utilizing a computer system as set forth in claim 1, further comprising entering and viewing the measurement data utilizing at least one workstation.

16. The method for monitoring facility data utilizing a computer system as set forth in claim 15, wherein the at least one workstation is selected from the group consisting of pocket processors, industrial computers, programmable logic controllers and personal computers.

17. The method for monitoring facility data utilizing a computer system as set forth in claim 15, wherein the computer system includes at least one main server that is able to transmit data with the at least one workstation through a group consisting of wireless communication, direct hardwired connection, local area networks, wireless communication, internet and wide area network.

18. The method for monitoring facility data utilizing a computer system as set forth in claim 15, wherein the at least one workstation includes associated information from the group consisting of at least one name of a workstation type, at least one indication as to whether a workstation type is portable, at least one name of a workstation manufacturer, contact information for a workstation manufacturer, at least one indication as to whether a workstation manufacturer is active, at least one name of a workstation model, at least one name of a workstation model manufacturer, at least one type of workstation and at least one indication as to whether a workstation model is active, at least one name of a specific workstation, at least one type of a specific workstation, at least one serial number for a specific workstation, and at least one indication as to whether a specific workstation is active.

19. The method for monitoring facility data utilizing a computer system as set forth in claim 1, further comprising evaluating the inputted measurement data from a plurality of measurement devices with the computer system in accordance with at least one predetermined test and providing a notification when the at least one predetermined test fails.

20. The method for monitoring facility data utilizing a computer system as set forth in claim 1, further comprising evaluating the inputted measurement data from a plurality of measurement devices with the computer system in accordance with at least one predetermined test and providing an assignable causes when the at least one predetermined test fails.

21. The method for monitoring facility data utilizing a computer system as set forth in claim 1, further comprising evaluating the inputted measurement data from a plurality of measurement devices with the computer system in accordance with at least one predetermined test and providing a recommended remedial action when the at least one predetermined test fails.

22. The method for monitoring facility data utilizing a computer system as set forth in claim 19, wherein the at least one predetermined test includes aspects selected from the group consisting of at least one predetermined target, a selection of a predetermined number of decimals from the predetermined target, an indication of whether there is zero tolerance regarding the predetermined target, a selection of an upper alert limit for the predetermined target, a selection of a lower alert limit for the predetermined target, a selection of an upper alarm limit for the predetermined target, a selection of an lower alarm limit for the predetermined target, a selection of an upper guard limit for the predetermined target, a selection of an lower guard limit for the predetermined target, a selectable maximum percentage of an upper limit, a selectable value for the maximum upper limit, an input for an alarm string, a corrective action procedure for the at least one predetermined test, an activation date for the at least one predetermined test, an activation time for the at least one predetermined test, a deactivation date for the at least one predetermined test and a deactivation time for the at least one predetermined test.

23. The method for monitoring facility data utilizing a computer system as set forth in claim 1, further comprising generating reports with the computer system.

24. The method for monitoring facility data utilizing a computer system as set forth in claim 23, wherein the generating reports with the computer system includes reports selected from the group consisting of at least one calibration report, at least one alert report, at least one alarm report, at least one corrective action report, at least one data edit report, at least one data verification report, at least one hold tag report, at least one preshipment review report, at least one report log report, at least one root cause report and at least one workstation schedule report.

25. The method for monitoring facility data utilizing a computer system as set forth in claim 23, further providing an electronic signature from at least one user for reports selected from the group of reports consisting of the at least one alarm report, the at least one data edit report, the at least one data verification report, and the at least one pre-shipment review report.

26. The method for monitoring facility data utilizing a computer system as set forth in claim 15, further comprising identifying at least one first user that provides the entering of the measurement data utilizing at least one workstation.

27. The method for monitoring facility data utilizing a computer system as set forth in claim 26, wherein the identifying at least one first user that provides the entering of the measurement data utilizing at least one workstation includes inputting a userid and a personal identification number to create an electronic signature.

28. The method for monitoring facility data utilizing a computer system as set forth in claim 26, further comprising observing verification of the entered measurement data by the at least one first user with at least one second user.

29. The method for monitoring facility data utilizing a computer system as set forth in claim 28, further comprising identifying the identity of the at least one second user by inputting a userid and a personal identification number to create an electronic signature.

30. The method for monitoring facility data utilizing a computer system as set forth in claim 19, wherein the failure of the at least one predetermined test generates an alarm.

31. The method for monitoring facility data utilizing a computer system as set forth in claim 19, further including generating at least one statistical process control chart utilizing the inputted measurement data.

32. The method for monitoring facility data utilizing a computer system as set forth in claim 1, wherein selective aspects of the computer system can be selectively blocked from view for a user depending on a predetermined security role determined for that user.

33. A method for monitoring facility data utilizing a computer system comprising:
inputting information relating to at least one part into the computer system;
inputting information relating to at least one field into the computer system;
inputting measurement data from a plurality of measurement devices;
entering and viewing measurement data utilizing at least one workstation; and
evaluating the inputted measurement data from a plurality of measurement devices with the computer system in accordance with at least one predetermined test and providing a notification when the at least one predetermined test fails.

34. A computer system for monitoring facility data comprising:
at least one input device for receiving information relating to at least one part and receiving information relating to at least one field; and
a plurality of measurement devices for receiving measurement data, wherein the inputted measurement data is at least partially correlated to the information related to the at least one part and the information related to the at least one field.

35. The computer system for monitoring facility data as set forth in claim 34, wherein the information relating to the at least one part includes at least one part type and at least one specific part and the information relating to the at least one field includes at least one field type and at least one specific field.

36. The computer system for monitoring facility data as set forth in claim 35, wherein the at least one part type is selected from the group consisting of types of components of products, types of subassemblies of products, types of fully assembled products, types of manufacturing machines and types of processing machines, wherein the at least one specific part includes information that is selected from the group consisting of at least one part name, at least one part type, at least one product code, at least one brand code, at least one regulatory category, at least one Hazard Analysis and Critical Control Point category and at least one product characteristic information and wherein the at least one field group is selected from the group consisting of bone types, zero tolerance items, reprocessed zero tolerance items, salvaged zero tolerance items, fecal contamination locations, sanitation standard operating procedures (SSOP) ratings and work-in-progress temperatures.

37. The computer system for monitoring facility data as set forth in claim 34, wherein the inputted measurement data that is correlated to the information related to the at least one part and the information that is related to the at least one field includes information selected from the group consisting of at least one type of unit of measurement, at least one specific unit of measurement, at least one type of test, at least one specific test, at least one type of measurement device, at least one manufacturer of a measurement device, at least one model of measurement device and at least one specific measurement device.

38. The computer system for monitoring facility data as set forth in claim 34, further comprising at least one workstation for entering and viewing the measurement data.

39. The computer system for monitoring facility data as set forth in claim 38, wherein the at least one workstation is selected from the group consisting of pocket processors, industrial computers, programmable logic controllers and personal computers.

40. The computer system for monitoring facility data as set forth in claim 34, further comprising at least one main server that is able to transmit data with the at least one workstation through a group consisting of wireless communication, direct hardwired connection, local area networks, wireless communication, internet and wide area network.

41. The computer system for monitoring facility data as set forth in claim 34, wherein the inputted measurement data is evaluated with the computer system with at least one predetermined test and a notification is provided if the at least one predetermined test fails.

42. The computer system for monitoring facility data as set forth in claim 34, wherein the computer system generates at least one report.

43. The computer system for monitoring facility data as set forth in claim 42, wherein the at least one report is selected from the group consisting of at least one calibration report, at least one alert report, at least one alarm report, at least one corrective action report, at least one data edit report, at least one data verification report, at least one hold tag report, at least one pre-shipment review report, at least one report log report, at least one root cause report and at least one workstation schedule report.

44. The computer system for monitoring facility data as set forth in claim 34, wherein the at least one workstation requires identification of at least one first user that provides the entering of the measurement data with an electronic signature.

45. The computer system for monitoring facility data as set forth in claim 34, wherein the at least one workstation requires identification of at least one second user that observes the entered measurement data by the at least one first user with an electronic signature.

46. The computer system for monitoring facility data as set forth in claim 34, wherein the computer system generates an alarm upon failure at least one predetermined test.

47. The computer system for monitoring facility data as set forth in claim 34, wherein the computer system generates a response from the group consisting of a recommended remedial action and an assignable cause.
